(19) United States
(12) Patent Application Publication
(10) Pub. No.: US 2024/0121733 A1
(43) Pub. Date: Apr. 11, 2024

(54) SHARING A FREQUENCY BAND BETWEEN LICENSED ACCESS AND UNLICENSED ACCESS

(71) Applicant: QUALCOMM Incorporated, San Diego, CA (US)

(72) Inventor: Aleksandar DAMNJANOVIC, Del Mar, CA (US)

(21) Appl. No.: 18/479,336

(22) Filed: Oct. 2, 2023

Related U.S. Application Data
(60) Provisional application No. 63/378,803, filed on Oct. 7, 2022.

(51) Int. Cl. H04W 56/00; H04W 16/14

(52) U.S. Cl. CPC H04W 56/0015; H04W 16/14

(57) ABSTRACT

Various aspects of the present disclosure generally relate to wireless communication. In some aspects, a first apparatus may receive a synchronization signal from an external device. The first apparatus may communicate in a wireless network using a licensed access protocol that is based at least in part on time division multiplexing (TDM) that uses a time boundary associated with the synchronization signal, the communicating being based at least in part on a frequency band that is allocated to a licensed access mode and an unlicensed access mode. A second apparatus may communicate in a wireless network using a synchronized unlicensed access protocol that is based at least in part on a synchronization signal time boundary associated with the synchronization signal, the communicating being based at least in part on the frequency band that is allocated to a licensed access mode and an unlicensed access mode. Numerous other aspects are described.

### CROSS-REFERENCE TO RELATED APPLICATION

This patent application claims priority to U.S. Provisional Patent Application No. 63/378,803, filed on Oct. 7, 2022, entitled “SHARING A FREQUENCY BAND BETWEEN LICENSED ACCESS AND UNLICENSED ACCESS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for sharing a frequency band between licensed access and unlicensed access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus. The method may include receiving a synchronization signal from an external device. The method may include communicating in a wireless network using a licensed access protocol that is based at least in part on time division multiplexing (TDM) that uses a time boundary associated with the synchronization signal, the communicating being based at least in part on a frequency band that is allocated to a licensed access mode and an unlicensed access mode.

Some aspects described herein relate to a method of wireless communication performed by an apparatus. The method may include receiving a synchronization signal from an external device. The method may include communicating in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode.

Some aspects described herein relate to a method of wireless communication performed by an apparatus. The method may include transmitting a first communication based at least in part on using an unsynchronized unlicensed access protocol that is associated with a frequency band that is allocated to a licensed access mode and an unlicensed access mode. The method may include deferring, based at least in part on the unsynchronized unlicensed access protocol, transmission of a second communication based at least in part on a derived synchronization signal time boundary.

Some aspects described herein relate to an apparatus for wireless communication. The apparatus may include one or more processors, one or more memories coupled with the one or more processors, and instructions stored in the one or more memories. The instructions may be executable by the one or more processors, individually, or collectively, to cause the apparatus to receive a synchronization signal from an external device. The instructions may be executable by the one or more processors, individually or collectively, to cause the apparatus to communicate in a wireless network using a licensed access protocol that is based at least in part on TDM that uses a time boundary associated with the synchronization signal, the licensed access protocol licensed access protocol being based at least in part on communicating in a frequency band that is allocated to a licensed access mode and an unlicensed access mode.

Some aspects described herein relate to an apparatus for wireless communication. The apparatus may include one or more processors, one or more memories coupled with the one or more processors, and instructions stored in the one or more memories. The instructions may be executable by the one or more processors, individually, or collectively, to cause the apparatus to receive a synchronization signal from an external device. The instructions may be executable by the one or more processors, individually or collectively, to cause the apparatus to communicate in a wireless network using a synchronized unlicensed access protocol that is based at least in part on a synchronization signal time boundary associated with the synchronization signal, the synchronized unlicensed access protocol being based at least in part on communicating in a frequency band that is allocated to a licensed access mode and an unlicensed access mode.

Some aspects described herein relate to an apparatus for wireless communication. The apparatus may include one or more processors, one or more memories coupled with the one or more processors, and instructions stored in the one or more memories. The instructions may be executable by the one or more processors, individually, or collectively, to cause the apparatus to transmit a first communication based at least in part on using an unsynchronized unlicensed access protocol that is associated with a frequency band that is allocated to a licensed access mode and an unlicensed access mode. The one or more processors may be configured, individually or collectively, to cause the apparatus to defer, based at least in part on the unsynchronized unlicensed access protocol, transmission of a second communication based at least in part on a derived synchronization signal time boundary.

Some aspects described herein relate to a non-transitory computer-readable medium that stores a set of instructions for wireless communication by an apparatus. The one or more instructions, when executed by one or more processors of the apparatus, may cause the apparatus to receive a synchronization signal from an external device. The set of instructions, when executed by the one or more processors of apparatus, may cause the apparatus to communicate in a wireless network using a licensed access protocol that is based at least in part on TDM that uses a time boundary associated with the synchronization signal, the communicating being based at least in part on a frequency band that is allocated to a licensed access mode and an unlicensed access mode.

Some aspects described herein relate to a non-transitory computer-readable medium that stores a set of instructions for wireless communication by an apparatus. The one or more instructions, when executed by one or more processors of the apparatus, may cause the apparatus to receive a synchronization signal from an external device. The set of instructions, when executed by the one or more processors of apparatus, may cause the apparatus to communicate in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode.

Some aspects described herein relate to a non-transitory computer-readable medium that stores a set of instructions for wireless communication by an apparatus. The one or more instructions, when executed by one or more processors of the apparatus, may cause the apparatus to transmit a first communication based at least in part on using an unsynchronized unlicensed access protocol that is associated with a frequency band that is allocated to a licensed access mode and an unlicensed access mode. The set of instructions, when executed by the one or more processors of apparatus, may cause the apparatus to defer, based at least in part on the unsynchronized unlicensed access protocol, transmission of a second communication based at least in part on a derived synchronization signal time boundary.

Some aspects described herein relate to an apparatus for wireless communication. The apparatus may include means for receiving a synchronization signal from an external device. The apparatus may include means for communicating in a wireless network using a licensed access protocol that is based at least in part on TDM that uses a time boundary associated with the synchronization signal, the communicating being based at least in part on a frequency band that is allocated to a licensed access mode and an unlicensed access mode.

Some aspects described herein relate to an apparatus for wireless communication. The apparatus may include means for receiving a synchronization signal from an external device. The apparatus may include means for communicating in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode.

Some aspects described herein relate to an apparatus for wireless communication. The apparatus may include means for transmitting a first communication based at least in part on using an unsynchronized unlicensed access protocol that is associated with a frequency band that is allocated to a licensed access mode and an unlicensed access mode. The apparatus may include means for deferring, based at least in part on the unsynchronized unlicensed access protocol, transmission of a second communication based at least in part on a derived synchronization signal time boundary.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIGS. 3A and 3B are diagrams illustrating a first example and a second example of a licensed access protocol, in accordance with the present disclosure.

FIG. 4 is a diagram illustrating an example of a synchronized unlicensed access protocol, in accordance with the present disclosure.

FIGS. 5A and 5B are diagrams illustrating a first example and a second example of an unsynchronized unlicensed access protocol, in accordance with the present disclosure.

FIG. 6 is a diagram illustrating an example of an unsynchronized unlicensed access protocol, in accordance with the present disclosure.

FIG. 7 is a diagram illustrating an example of a wireless communication process between a first pair of apparatuses and a second pair of apparatuses, in accordance with the present disclosure.

FIG. 8 is a diagram illustrating an example process performed, for example, by an apparatus, in accordance with the present disclosure.

FIG. 9 is a diagram illustrating an example process performed, for example, by an apparatus, in accordance with the present disclosure.

FIG. 10 is a diagram illustrating an example process performed, for example, by an apparatus, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

The demand for services provided by a wireless network continues to increase as more and more devices access the wireless network. The availability of communication resources (e.g., frequency resources and/or time resources) to provide these services becomes proportionally strained as the number of devices accessing the wireless network increases. To increase capacity, a same portion of spectrum may be shared between licensed access and unlicensed access. For example, the same portion of spectrum may be allocated to licensed access at an outdoor location and unlicensed access at an indoor location. “Licensed access” may denote a communication and/or access protocol that is based at least in part on using licensed spectrum. A device may transmit and/or receive wireless communications within licensed spectrum based at least in part on an expectation that other devices will refrain from using the licensed spectrum at a same time. “Unlicensed access” may denote a communication and/or access protocol that is based at least in part on using unlicensed spectrum.

A coexistence between licensed access and unlicensed access in a same portion of spectrum may increase a capacity of a wireless network, but also result in increased interference observed by a receiver. To illustrate, at least a portion of a licensed transmission may occur at a same time as an unlicensed transmission. The increased interference may reduce signal quality, increase recovery errors, reduce data throughput, and/or increase data transfer latencies.

Some techniques and apparatuses described herein provide sharing a frequency band between licensed access and unlicensed access. In some aspects, an apparatus may receive a synchronization signal from an external device. The apparatus may communicate in a wireless network using a licensed access protocol that is based at least in part on time division multiplexing (TDM) that uses a time boundary associated with the synchronization signal. In some aspects, communicating in the wireless network using the licensed access protocol is based at least in part on a frequency band that is allocated to a licensed access mode and an unlicensed access mode.

In some aspects, an apparatus may receive a synchronization signal from an external device. The apparatus may communicate in a wireless network using a synchronized unlicensed access protocol that is based at least in part on a synchronization signal time boundary associated with the synchronization signal. In some aspects, communicating in the wireless network using the synchronized unlicensed access protocol is based at least in part on a frequency band that is allocated to a licensed access mode and an unlicensed access mode.

In some aspects, an apparatus may transmit a first communication based at least in part on using an unsynchronized unlicensed access protocol that is associated with a frequency band that is allocated to a licensed access mode and an unlicensed access mode. The apparatus may defer, based at least in part on the unsynchronized unlicensed access protocol, transmission of a second communication based at least in part on a derived synchronization signal time boundary.

Coordinating licensed access and unlicensed access to a same portion of spectrum may increase a capacity of a wireless network and reduce interference observed by a receiver. The reduced interference may increase signal quality, reduce recovery errors, increase data throughput, and/or reduce data transfer latencies.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

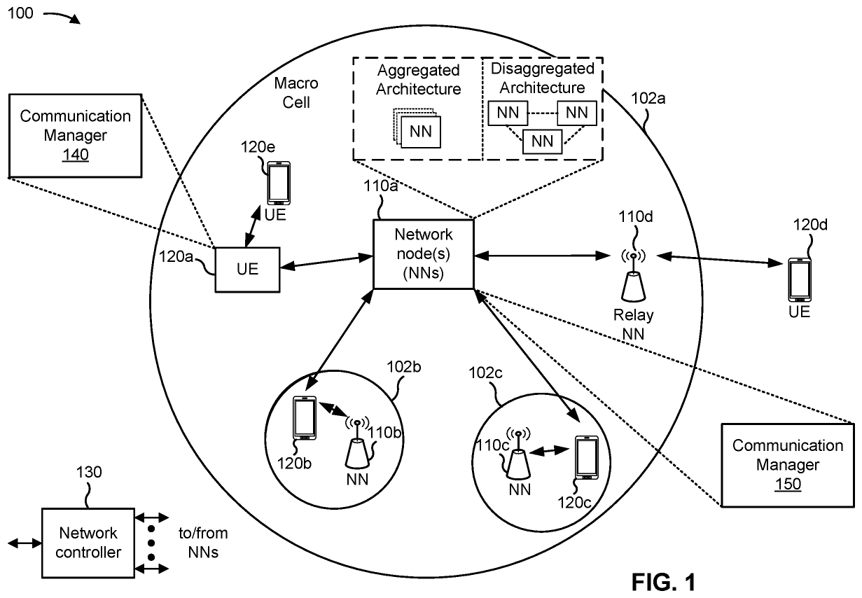

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an apparatus (e.g., a network node 110 or a UE 120) may include a communication manager 140. Alternatively, the apparatus may include a communication manager 150. As described in more detail elsewhere herein, the communication manager 140 and/or the communication manager 150 may receive a synchronization signal from an external device; and communicate in a wireless network using a licensed access protocol that is based at least in part on TDM that uses a time boundary associated with the synchronization signal, the communicating being based at least in part on a frequency band that is allocated to a licensed access mode and an unlicensed access mode. Additionally, or alternatively, the communication manager 140 and/or the communication manager 150 may perform one or more other operations described herein.

Alternatively, the communication manager 140 and/or the communication manager 150 may receive a synchronization signal from an external device; and communicate in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode. Additionally, or alternatively, the communication manager 140 and/or the communication manager 150 may perform one or more other operations described herein.

Alternatively, the communication manager 140 and/or the communication manager 150 may transmit a first communication based at least in part on using an unsynchronized unlicensed access protocol that is associated with a frequency band that is allocated to a licensed access mode and an unlicensed access mode; and defer, based at least in part on the unsynchronized unlicensed access protocol, transmission of a second communication based at least in part on a derived synchronization signal time boundary. Additionally, or alternatively, the communication manager 140 and/or the communication manager 150 may perform one or more other operations described herein.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As indicated above, FIG. 1 is provided as an example. Other examples may differ from what is described with regard to FIG. 1.

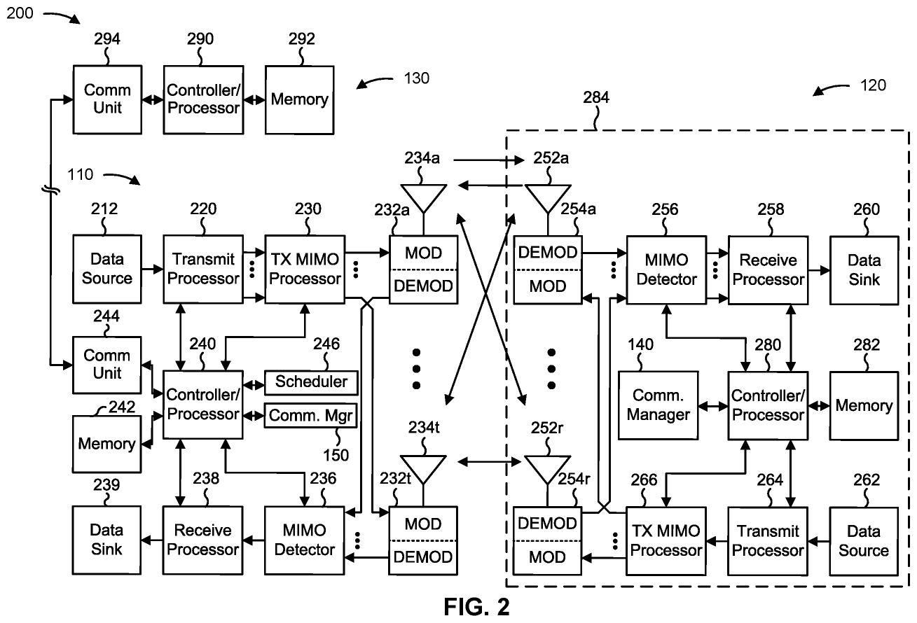

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

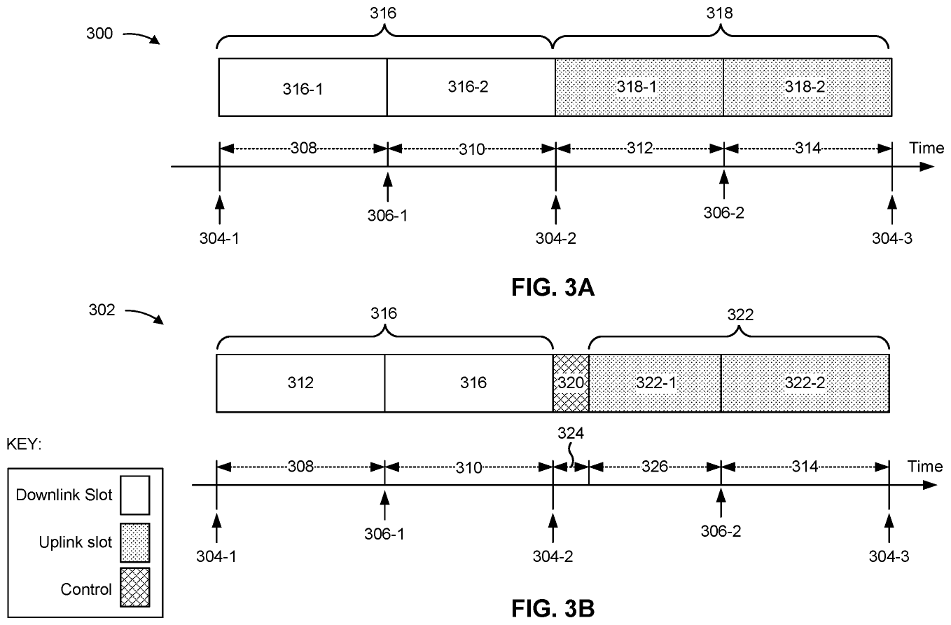

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3A-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3A-12).

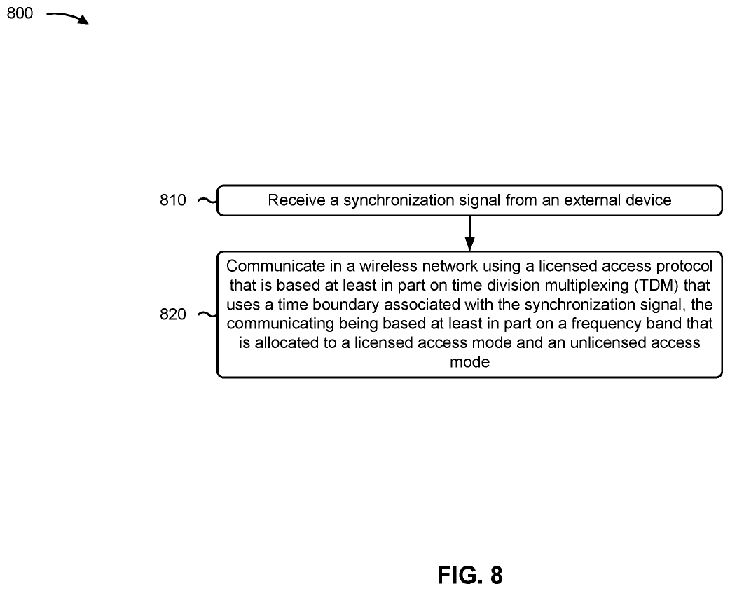

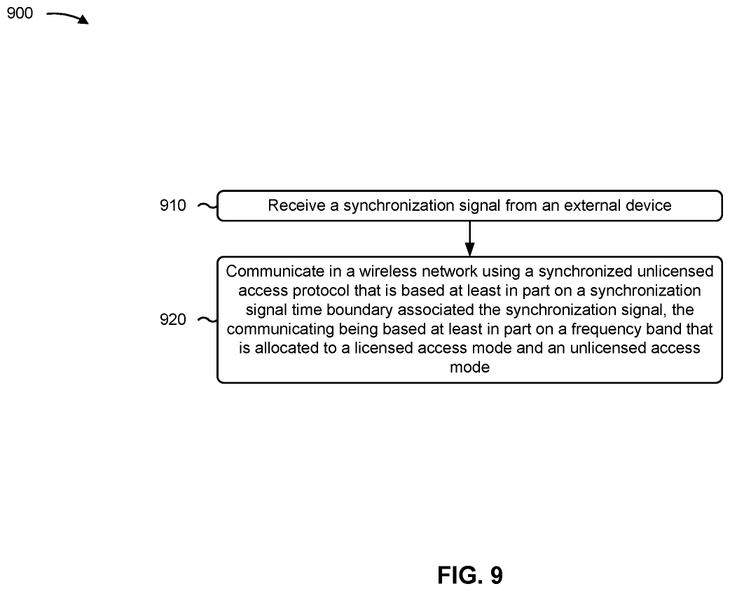

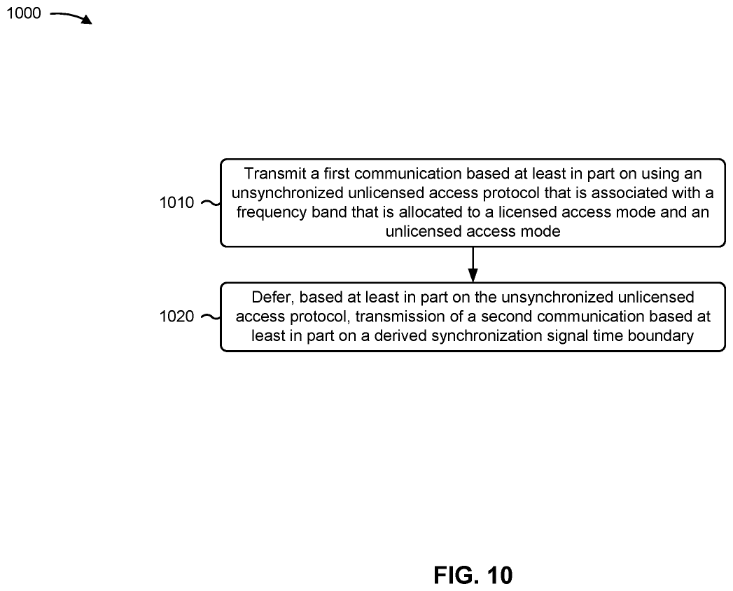

The controller/processor 240 of the network node 110, the controller/processor 280 of the UE 120, and/or any other component(s) of FIG. 2 may perform one or more techniques associated with sharing a frequency band between licensed access and unlicensed access, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, an apparatus (e.g., network node 110 or UE 120) includes means for receiving a synchronization signal from an external device; and/or means for communicating in a wireless network using a licensed access protocol that is based at least in part on TDM that uses a time boundary associated with the synchronization signal, the communicating being based at least in part on a frequency band that is allocated to a licensed access mode and an unlicensed access mode. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Alternatively, in some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an apparatus (e.g., network node 110 or UE 120) includes means for receiving a synchronization signal from an external device; and/or means for communicating in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Alternatively, in some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an apparatus (e.g., network node 110 or UE 120) includes means for transmitting a first communication based at least in part on using an unsynchronized unlicensed access protocol that is associated with a frequency band that is allocated to a licensed access mode and an unlicensed access mode; and/or means for deferring, based at least in part on the unsynchronized unlicensed access protocol, transmission of a second communication based at least in part on a derived synchronization signal time boundary. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. Alternatively, in some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

The demand for services provided by a wireless network continues to increase as more and more devices access the wireless network. The availability of communication resources (e.g., frequency resources and/or time resources) to provide these services becomes proportionally strained as the number of devices accessing the wireless network increases. To increase capacity, a same portion of spectrum, such as a millimeter wave band (e.g., above 6 GHz and/or FR2 frequencies), may be shared between licensed access and unlicensed access. For example, the same portion of spectrum may be allocated to licensed access at an outdoor location and unlicensed access at an indoor location.

“Licensed access” may denote a communication and/or access protocol that is based at least in part on using licensed spectrum. “Licensed spectrum” may denote a portion of spectrum that a governing body (e.g., the Federal Communications Commission (FCC), the ITU, and/or the Ministry of Communication) has granted, allocated, and/or assigned the exclusive access rights to a specific purpose. As one example, the FCC has assigned a first portion of spectrum to maritime mobile usage, a second portion of spectrum to broadcasting satellite communications, and a third portion of spectrum to mobile communications. Based at least in part on the exclusive access rights associated with the portion of spectrum, a device may transmit and/or receive wireless communications within the licensed spectrum based at least in part on an expectation that other devices will refrain from using the licensed spectrum at a same time. Accordingly, a device that accesses spectrum using licensed access may experience reduced interference from other devices. “Unlicensed access” may denote a communication and/or access protocol that is based at least in part on using unlicensed spectrum. “Unlicensed spectrum” may denote frequency spectrum that may be utilized by any device without exclusive access (e.g., a portion of frequency that may be accessed without a license). That is, maritime mobile usage, broadcasting satellite communications, and/or mobile communications may each utilize a same portion of unlicensed spectrum.

A coexistence between licensed access and unlicensed access in a same portion of spectrum (e.g., a millimeter wave band and/or a frequency band) may increase a capacity of a wireless network, but also result in increased interference observed by a receiver. To illustrate, at least a portion of a licensed transmission may occur at a same time as an unlicensed transmission. The increased interference may reduce signal quality, increase recovery errors, reduce data throughput, and/or increase data transfer latencies.

Some techniques and apparatuses described herein provide sharing a frequency band between licensed access and unlicensed access. In some aspects, an apparatus (e.g., a network node 110 and/or a UE 120) may receive a synchronization signal from an external device. The apparatus may communicate in a wireless network using a licensed access protocol that is based at least in part on TDM that uses a time boundary associated with the synchronization signal. In some aspects, communicating in the wireless network using the licensed access protocol is based at least in part on a frequency band that is allocated to a licensed access mode and an unlicensed access mode.

In some aspects, an apparatus (e.g., a network node 110 and/or a UE 120) may receive a synchronization signal from an external device. The apparatus may communicate in a wireless network using a synchronized unlicensed access protocol that is based at least in part on a synchronization signal time boundary associated with the synchronization signal. In some aspects, communicating in the wireless network using the synchronized unlicensed access protocol is based at least in part on a frequency band that is allocated to a licensed access mode and an unlicensed access mode.

In some aspects, an apparatus (e.g., a network node 110 and/or a UE 120) may transmit a first communication based at least in part on using an unsynchronized unlicensed access protocol that is associated with a frequency band that is allocated to a licensed access mode and an unlicensed access mode. The apparatus may defer, based at least in part on the unsynchronized unlicensed access protocol, transmission of a second communication based at least in part on a derived synchronization signal time boundary.

Coordinating licensed access and unlicensed access to a same portion of spectrum may increase a capacity of a wireless network and reduce interference observed by a receiver. The reduced interference may increase signal quality, reduce recovery errors, increase data throughput, and/or reduce data transfer latencies.

FIGS. 3A and 3B are diagrams illustrating a first example 300 and a second example 302, respectively, of a licensed access protocol, in accordance with the present disclosure. In some aspects, the licensed access protocol may be based at least in part on accessing a portion of spectrum that is allocated to both licensed access and unlicensed access, and may be associated with a first portion of spectrum included a millimeter wave band, a second portion of spectrum above the millimeter wave band, and/or a third portion of spectrum below the millimeter wave band. The licensed access protocol shown by the first example 300 and the second example 302 may alternatively be referred to as a synchronized licensed access protocol. At least some aspects of the licensed access protocol shown by the first example 300 and the second example 302 may be specified by a communication standard.

The licensed access protocol shown by the first example 300 and the second example 302 may use TDM that is based at least in part on a synchronization signal, such as a global navigation satellite system (GNSS) synchronization signal. To illustrate, a device may include a GNSS receiver that receives the GNSS synchronization signal, and the device may process the GNSS synchronization signal to derive a time base. However, the licensed access protocol may base the TDM on other types of synchronization signals, such as a synchronization signal transmitted by a primary network node servicing device. In some aspects, the synchronization signal may be generated by a first device that is external to both a second device and a third device communicating with one another. In some aspects, the first device may transmit the synchronization signal based at least in part on a first RAN that is different from a second RAN used by the second and third devices to communicate and/or a different time structure. However, in other aspects, the synchronization signal may be generated by a primary network node associated with the licensed access protocol. In some aspects, the device may periodically receive the synchronization signals and/or periodically update the time based at least in part on receiving the synchronization signal(s).

As shown by the first example 300 and the second example 302, the device may identify a first synchronization signal time boundary 304-1 based at least in part on a first occurrence of the synchronization signal, a second synchronization signal time boundary 304-2 based at least in part on a second occurrence of the synchronization signal, and/or a third synchronization signal time boundary 304-3 based at least in part on a third occurrence of the synchronization signal. In some aspects, the device may identify the first synchronization signal time boundary 304-1, the second synchronization signal time boundary 304-2, and/or the third synchronization signal time boundary 304-3 based at least in part on deriving the time base using a first synchronization signal, updating the time base based at least in part on receiving a second synchronization signal, and/or receiving a respective synchronization signal for each time boundary. For instance, the device may receive a first synchronization signal associated with the first synchronization signal time boundary 304-1, derive a time base, and identify the second synchronization signal time boundary 304-2 based at least in part on the derived time base. As another example, the device may receive a second synchronization signal associated with the second synchronization signal time boundary 304-2 and/or a third synchronization signal associated with the third synchronization signal time boundary 304-3. While the example 300 and the example 302 show three synchronization signal time boundaries, other examples may include more or fewer time boundaries associated with more or fewer occurrences of the synchronization signal.

The TDM partitions associated with the licensed access protocol may be based at least in part on a synchronization signal time boundary. To illustrate, and as shown in FIGS. 3A and 3B, the licensed access protocol may specify a time slot boundary based at least in part on a synchronization signal time boundary. For instance, a first time slot may begin at the first synchronization signal time boundary 304-1 and end at the first time slot time boundary 306-1. That is, the first time slot may be based at least in part on a time duration 308 that is bounded by the first synchronization signal time boundary 304-1 and the first time slot time boundary 306-1. A second time slot may begin at the first time slot time boundary 306-1, end at the second synchronization signal time boundary 304-2, and have a time duration 310. A third time slot may begin at the second synchronization signal time boundary 304-2, end at a second time slot time boundary slot boundary 306-2, and have a time duration 312. Alternatively or additionally, a fourth time slot may begin at the second time slot time boundary 306-2, end at the third synchronization signal time boundary 304-3, and have a time duration 314. While the first example 300 and the second example 302 show the licensed access protocol partitioning a time duration between synchronization signal time boundaries into two time slots, other examples may include the licensed access protocol partitioning the time duration into more or fewer time slots.

In some aspects, the licensed access protocol may specify that a new transmission must begin at a synchronization signal time boundary. For example, a network node (e.g., the network node 110) transmitting a downlink signal 316 (shown as including at least a first portion 316-1 and a second portion 316-2) may delay transmission of the downlink signal 316 until the first synchronization signal time boundary 304-1. That is, the network node may refrain from starting the downlink signal 316 at a non-synchronization signal time boundary (e.g., the first time slot boundary 306-1 and the second time slot boundary 306-2). The network node may wait until an occurrence of a synchronization signal time boundary (e.g., the first synchronization signal time boundary 304-1, the second synchronization signal time boundary 304-2, and/or the third synchronization signal time boundary 304-3) to begin transmission of the downlink signal 316. Alternatively or additionally, a UE (e.g., the UE 120) may delay transmission of an uplink signal 318 (shown as including a first portion 318-1 and a second portion 318-2) until an occurrence of a synchronization signal time boundary (e.g., the second synchronization signal time boundary 304-2).

As shown by the first example 300, a network node may transmit the downlink signal, and/or a UE may transmit the uplink signal 318, without performing a clear channel assessment (CCA) and/or a listen-before-talk (LBT) procedure based at least in part on utilizing the licensed access protocol. However, in some aspects and as shown by the second example 302, a UE (e.g., the UE 120) may perform a CCA procedure 320 (e.g., a single CCA procedure, multiple CCA procedures, and/or as part of an LBT procedure) prior to transmitting an uplink signal 322 (shown as including a first portion 322-1 and a second portion 322-2). In some aspects, the UE may optionally perform the CCA procedure over a time duration 324 and prior to transmitting the uplink signal 322. Alternatively or additionally, the licensed access protocol may instruct the UE to perform the CCA procedure prior to starting a new transmission. A CCA procedure may include a device measuring a power level in a frequency band and/or frequency sub-band, and comparing the power level to a threshold to determine whether the frequency band is free of other transmissions.

In some aspects, the licensed access protocol may specify that the time duration 324 associated with the CCA procedure 320 must start at a synchronization signal time boundary (e.g., the second synchronization signal time boundary 304-2). The UE may transmit the uplink signal 322 based at least in part on the CCA procedure 320 clearing. “Clearing” a CCA may denote that a device detects that a power level in the measured frequency band (e.g., a millimeter wave band) satisfies a low power threshold. That is, the device may detect that an energy level of a communication channel associated with the frequency band is at or below a specified level. Accordingly, the UE may transmit the uplink signal 322 at least in a remaining portion of a time slot (shown as time duration 326) that is associated with performing the CCA procedure that indicates the communication channel is available for use.

Using a synchronization signal (e.g., generated by a device other than the network node and the UE) enables a first transmission associated with licensed access by a first device to be synchronized with a second transmission associated with unlicensed access by a second device (as further described below) based at least in part on each access protocol using a common time base. Synchronizing licensed access with unlicensed access may reduce the occurrence of collisions, improve signal quality, reduce recovery errors, increase data throughput, and/or reduce data transfer latencies.

As indicated above, FIGS. 3A and 3B are provided as examples. Other examples may differ from what is described with regard to FIGS. 3A and 3B.

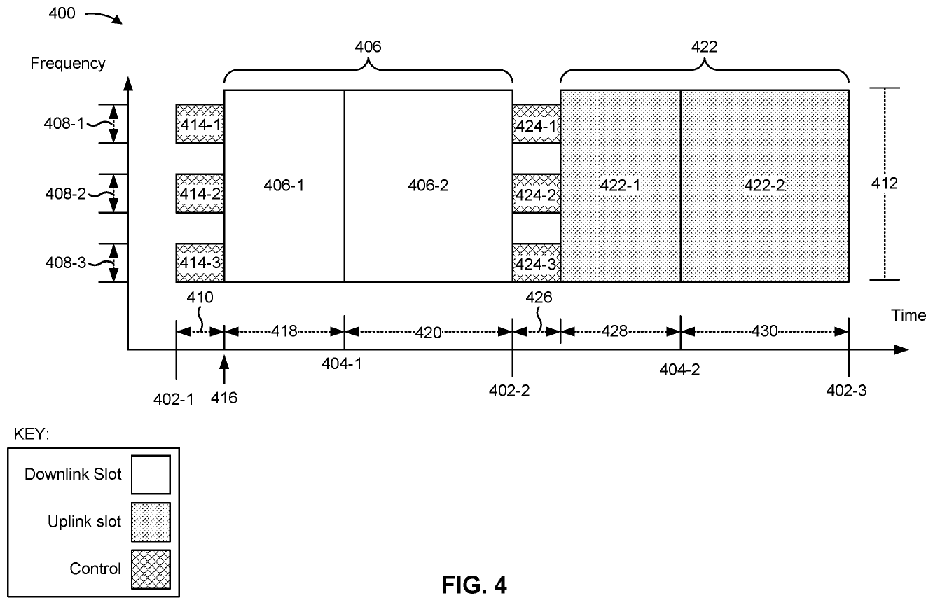

FIG. 4 is a diagram illustrating an example 400 of a synchronized unlicensed access protocol, in accordance with the present disclosure. In some aspects, the synchronized unlicensed access protocol shown by the example 400 may be associated with accessing a portion of spectrum that is allocated to both licensed access and unlicensed access. As one example, the portion of spectrum may be associated with a millimeter wave band, but other examples may include portions of spectrum above a millimeter wave band or below a millimeter wave band. The synchronized unlicensed access protocol shown by the example 400 may alternatively be referred to as an unlicensed access protocol. At least some aspects of the synchronized unlicensed access protocol shown by the example 400 may be specified by a communication standard.

The synchronized unlicensed access protocol shown by the example 400 may use TDM that is based at least in part on a synchronization signal, such as a GNSS synchronization signal. To illustrate, a device (e.g., the network node 110 and/or the UE 120) may receive the synchronization signal and process the synchronization signal to derive a time base. Processing the synchronization signal may include updating the time base using additional synchronization signal(s).

As shown by the example 400, a device (e.g., the network node 110 and/or the UE 120) may detect, identify, and/or derive a first synchronization signal time boundary 402-1, a second synchronization time boundary 402-2, and/or a third synchronization signal time boundary 402-3 based at least in part on at least a first occurrence of the synchronization signal (e.g., a GNSS synchronization signal). In some aspects, the device may detect the first synchronization signal time boundary 402-1 based at least in part on the first occurrence of the synchronization signal, and derive the second synchronization signal time boundary 402-2, and/or the third synchronization signal third time boundary 402-3 based at least in part on a derived time base, as further described above. Alternatively or additionally, and as part of the synchronized unlicensed access, the device may receive a configuration parameter, and calculate the synchronization signal time boundary based at least in part on the configuration parameter. Some non-limiting examples of a configuration parameter may include one or more of an energy threshold, a contention window size, a listen-before-talk configuration parameter, an interframe space length, a backoff configuration, and/or a synchronization period. However, other examples may include alternate or additional unlicensed access protocol configuration parameters. In some aspects, the device may refrain from transmitting an access probe until receiving the synchronization signal and/or until deriving the time base.

Alternatively or additionally, a device (e.g., the network node 110) may transmit a beacon based at least in part on using an air interface resource specified by a communication standard. As one example, the device may transmit a beacon in a time slot (specified by the communication standard) configured to mitigate collisions.

In some aspects, the synchronized unlicensed access protocol shown by the example 400 may be based at least in part on TDM partitions associated with a synchronization signal time boundary. To illustrate, the synchronized unlicensed access protocol may specify a time slot boundary based at least in part on a synchronization signal time boundary. Alternatively or additionally, the synchronized unlicensed access protocol may specify a time slot boundary based at least in part on partitioning a time duration between synchronization signal time boundaries. For instance, and as shown by the example 400, the synchronized unlicensed access protocol may specify that a first time slot begins at the first synchronization signal time boundary 402-1 and ends at a first time slot time boundary 404-1. Alternatively or additionally, the synchronized unlicensed access protocol may specify that a second time slot begins at the first time slot time boundary 404-2 and ends at the second synchronization signal time boundary 404-2, that a third time slot begins at the second synchronization signal time boundary 402-2 and ends at a second time slot time boundary 404-2, and/or that a fourth time slot may begin at the second time slot time boundary 404-2 and end at the third synchronization signal time boundary 402-3. Accordingly, the pattern and/or configuration of the time slot time boundaries relative to the synchronization signal time boundaries may repeat over time. While the example 400 shows the synchronized unlicensed access protocol partitioning a time duration between synchronization signal time boundaries into two time slots, other examples may include the synchronized unlicensed access protocol partitioning the time duration into more or fewer time slots.

The synchronized unlicensed access protocol may specify that a new transmission must begin at a synchronization signal time boundary. In some aspects, the synchronized unlicensed access protocol may specify to transmit a reserve signal using a primary channel and/or a control channel. Alternatively or additionally, the synchronized unlicensed access protocol may specify to perform a CCA procedure (e.g., a single CCA procedure, multiple CCA procedures, and/or as part of an LBT procedure) prior to transmission of the new transmission. To illustrate, a network node (e.g., the network node 110) may determine to transmit a downlink signal 406 (shown as a first portion 406-1 and a second portion 406-2). Based at least in part on a start of the downlink signal 406 being a start of a new transmission, the network node may delay transmission of the downlink signal 406 until the first synchronization signal time boundary 402-1.

In some aspects, the synchronized unlicensed access protocol shown by the example 400 may allocate air interface resources (e.g., frequency resources and/or time resources) to a primary channel and/or control channel transmission (e.g., a downlink control channel and/or an uplink control channel), such as a reserve signal as further described below. To illustrate, and as shown by the example 400, the synchronized unlicensed access protocol may allocate air interface resources associated with any combination of a first sub-band 408-1, a second sub-band 408-2, and/or a third sub-band 408-3 (e.g., within a frequency band 412) and time duration 410 that is bounded by a synchronization signal time boundary to the primary channel and/or control channel transmission. Accordingly, a device may transmit, during the time duration 410, a reserve signal that indicates that the device intends to transmit in subsequent air interface resources associated with the frequency band 412 and/or that the device is reserving the subsequent air interface resources. The reserve signal may be transmitted with a higher power spectral density relative to a downlink data transmission and/or an uplink data transmission, and may be transmitted based at least in part on any combination of the first sub-band 408-1, the second sub-band 408-2, and/or the third sub-band 408-3. Accordingly, the network node may transmit the reserve signal using a primary channel and/or a downlink control channel and based at least in part on the allocated air interface resources as shown by reference number 414-1, reference number 414-2, and/or reference number 414-3.

Alternatively or additionally, the synchronized unlicensed access protocol may instruct a device (e.g., the network node 110 and/or the UE 120) to perform the CCA procedure prior to transmitting a new signal and based at least in part on the air interface resources associated with the first sub-band 408-1, the second sub-band 408-2, the third sub-band 408-3, and/or the time duration 410. To illustrate, the network node may perform a CCA procedure (e.g., a single CCA procedure, multiple CCA procedures, and/or as part of an LBT procedure) during a first portion of the time duration 410 that begins at the first synchronization signal time boundary 402-1, and transmit a reserve signal during a second portion of the time duration 410. As another example, the network node may transmit the reserve signal using a first sub-band (e.g., the first sub-band 408-1) and perform the CCA procedure using another sub-band (e.g., the third sub-band 408-3 that is furthest away from the transmission). Accordingly, the network node may transmit a reserve signal and/or perform a CCA procedure during the time duration 410 using any combination of the first sub-band 408-1, the second sub-band 408-2, and/or the third sub-band 408-3. Based at least in part on transmitting the reserve signal and/or the CCA (or LBT) procedure clearing, the network node may transmit the downlink signal 406, which is shown in the example 400 as spanning a time duration 418 that is associated with a first time slot (e.g., bounded by the first synchronization signal time boundary 402-1) and a time duration 420 that is associated with a second time slot (e.g., bounded by the second synchronization signal time boundary 402-2). However, the downlink signal 406 may span longer or shorter time durations in other examples.

Based at least in part on instructions associated with the synchronized unlicensed access protocol shown by the example 400, a UE (e.g., the UE 120) may delay transmission of an uplink signal 422 (shown as including a first portion 422-1 and a second portion 422-2) until an occurrence of a synchronization signal time boundary (e.g., the second synchronization signal time boundary 402-2). As shown by reference number 424-1, reference number 424-2, and/or reference number 424-3, the UE may transmit a reserve signal (e.g., with higher power spectral density relative to an uplink data transmission) and/or perform a CCA procedure (e.g., a single CCA procedure, multiple CCA procedures, and/or as part of an LBT procedure) during a time duration 426 that begins at the start of a synchronization signal time boundary (shown as the second synchronization signal time boundary 406-2). The UE may transmit the reserve signal and/or perform the CCA procedure using any combination of the first sub-band 408-1, the second sub-band 408-2, the third sub-band 408-3, and/or the time duration 426. Based at least in part on transmitting the reserve signal and/or the CCA procedure clearing, the UE may transmit the uplink signal 422, which is shown in the example 400 as spanning a time duration 428 that is associated with a third time slot (e.g., bounded by the second synchronization signal time boundary 402-2) and a time duration 430 that is associated with a fourth time slot (e.g., bounded by the third synchronization signal time boundary 402-3). However, the uplink signal 422 may span longer or shorter time durations in other examples.

Using a synchronization signal enables a first transmission associated with licensed access by a first device to be synchronized with a second transmission associated with unlicensed access by a second device based at least in part on each access protocol using a common time base. To illustrate, the licensed protocol access described with regard to the first example 300 and/or the second example 302, as well as the unlicensed protocol access described with regard to the example 400, may both specify to begin a new transmission at a start of a synchronization signal time boundary that is common to both licensed access and unlicensed access. Alternatively or additionally, the licensed protocol access and the unlicensed protocol access may specify to perform a CCA procedure prior to starting a new transmission to mitigate collisions. Synchronizing licensed access with unlicensed access may reduce the occurrence of collisions, improve signal quality, reduce recovery errors, increase data throughput, and/or reduce data transfer latencies.

As indicated above, FIG. 4 is provided as an example. Other examples may differ from what is described with regard to FIG. 4.

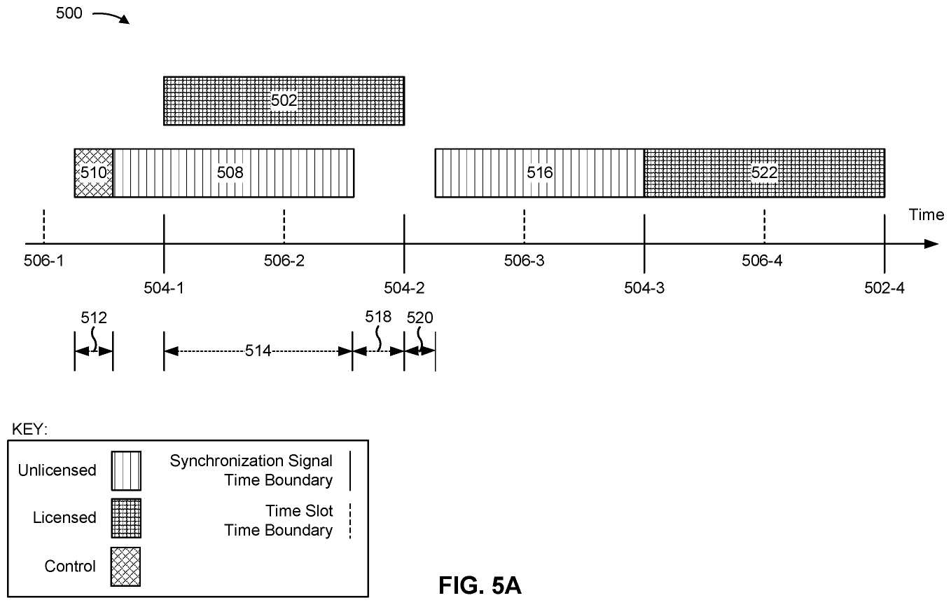

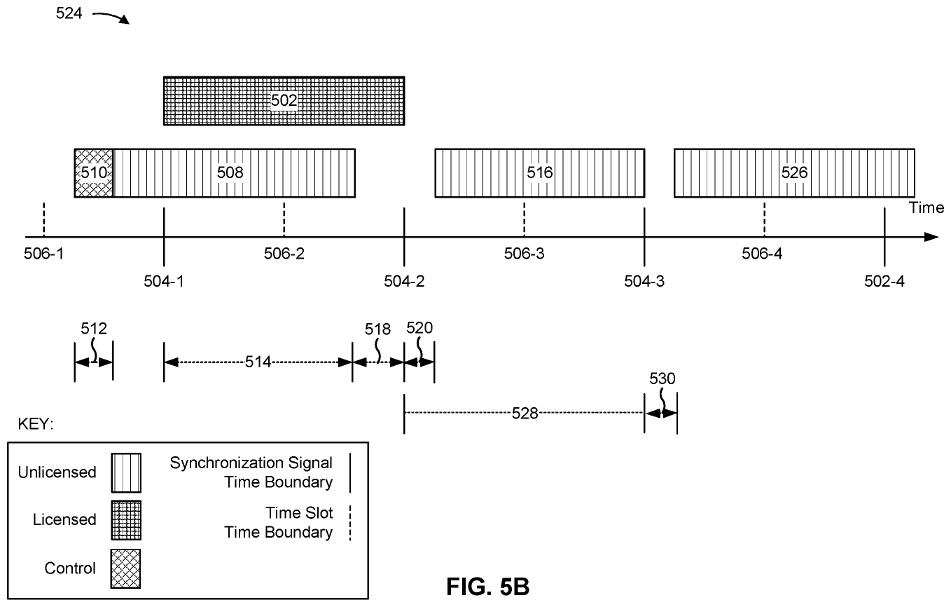

FIGS. 5A and 5B are diagrams illustrating a first example 500 and a second example 524 of an unsynchronized unlicensed access protocol, in accordance with the present disclosure. In some aspects, the unsynchronized unlicensed access protocol may be associated with accessing a portion of spectrum that is allocated to both licensed access and unlicensed access, such as a first portion of spectrum within a millimeter wave band, a second portion of spectrum above the millimeter wave band, and/or a third portion of spectrum below a millimeter wave band. The unsynchronized unlicensed access protocol shown by the first example 500 and/or the second example 524 may alternatively be referred to as an unlicensed access protocol. At least some aspects of the unsynchronized unlicensed access protocol shown by the first example 500 and/or the second example 524 may be specified by a communication standard.

The first example 500 shows a first licensed access transmission 502 generated by a first device (e.g., the network node 110 and/or the UE 120) based at least in part on a licensed access protocol as described with regard to FIGS. 3A and 3B. For example, the first device may detect, identify, and/or derive a first synchronization signal time boundary 504-1, a second synchronization time boundary 504-2, and/or a third synchronization signal time boundary 504-3 based at least in part on receiving a synchronization signal. Alternatively or additionally, and based at least in part on the synchronization signal, the first device may derive a time base. Using the time base, the first device may identify a first time slot time boundary 506-1, a second time slot time boundary 506-2, a third time slot time boundary 506-3, and/or a fourth time slot time boundary 506-4 that are associated with TDM as specified by the licensed access protocol. Accordingly, the first device may synchronize transmission of the first licensed access transmission 502 based at least in part on the first synchronization signal time boundary 504-1. That is, the first device may delay transmission of the first licensed access transmission 502 until the first synchronization signal time boundary 504-1, as further described with regard to FIGS. 3A and 3B.

The first example 500 also shows a first unlicensed access transmission 508 generated by a second device (e.g., another network node 110 and/or another UE 120) based at least in part on using an unsynchronized unlicensed protocol access. In some aspects, and based at least in part on using the unsynchronized unlicensed protocol access, the second device may not derive a common time base with the first device using a same synchronization signal. That is, the second device may lack information about the synchronization signal time boundary 504-1 used by the first device and, thus, may be unsynchronized with the first device. In some aspects, the second device may perform a CCA procedure (e.g., a single CCA procedure, multiple CCA procedures, and/or as part of an LBT procedure) as shown by reference number 510 during a time duration 512 and prior to transmitting the first unlicensed access transmission 508. In some aspects, the unsynchronized unlicensed access protocol may instruct a device to perform the CCA procedure during the time duration 512 and/or indicate one or more time boundaries associated with the time duration 512 (e.g., an LBT start time boundary and/or an LBT pass time duration). Based at least in part on the unsynchronized unlicensed access, a portion of the first licensed access transmission 502 and a portion of the first unlicensed access transmission 508 may collide, as shown by reference number 514.

Based at least in part on accessing the shared portion of spectrum using the unsynchronized unlicensed access protocol, the second device may operate in a restricted access mode, such as a mode with lower power, a lower duty cycle, a shorter channel occupancy time and/or a longer back off relative to the synchronized unlicensed access protocol and/or the licensed access protocol. That is, the restricted access mode may be based at least in part on reduced access to the shared portion of spectrum relative to the synchronized unlicensed access. As one example, the unsynchronized unlicensed access protocol may specify a time duration in which transmissions are disallowed. To illustrate, the unsynchronized unlicensed access protocol may be based at least in part on a distributed coordinated function interframe space (DIFS) such that the second device may be restricted from transmitting a second unlicensed access transmission 516 until a minimum time duration has occurred (e.g., after the completion of the first unlicensed access transmission 508). Alternatively or additionally, the unsynchronized unlicensed protocol access may specify that transmissions are disallowed if a device senses energy in a frequency band. For instance, and based at least in part on using the unsynchronized unlicensed protocol access, the second device may perform a second CCA procedure prior to transmitting the second unlicensed access transmission 516. A time duration of the second unlicensed access transmission 516 may be based at least in part on a channel occupancy time (COT).

In some aspects, the first device may wait a minimum time duration before performing the second CCA procedure. As one example, the second device may calculate, based at least in part on the unsynchronized unlicensed access protocol, a minimum time duration, a synchronization period, and/or a deferral period. For instance, the second device may calculate the synchronization period using a maximum channel occupancy time (MCOT), an interframe space (IFS) size, a contention window size (e.g., a contention back off window time), and a COT:

MCOT size=IFS+contention back off time+COT=synchronization period (1)

Based at least in part on the equation (1), the second device may calculate a minimum time duration to wait before attempting to transmit the second unlicensed access transmission 516. That is, the minimum time duration may indicate a minimum time to wait before starting a contention back of timer (e.g., an LBT countdown time duration). In some aspects, the second device may receive a configuration parameter associated with the unsynchronized unlicensed access protocol, and calculate a derived synchronization signal time boundary and/or a minimum time duration based at least in part on the configuration parameter. For example, the configuration parameter may include one or more of an energy threshold, a contention window size, a listen-before-talk configuration parameter, an IFS length, a backoff configuration, and/or a synchronization period. However, other examples may include alternate or additional unlicensed access protocol configuration parameters.

At an end of the minimum time duration, the second device may perform the second CCA procedure and measure a power level that satisfies an energy detected (ED) threshold (e.g., due to a presence of the first licensed access transmission 502). That is, the second device may measure the power level in the shared portion of spectrum during a time duration 518. The second device may repeatedly measure the power level during the time duration 518 until the measured power level is below the ED threshold (shown as occurring at an end of the time duration 518). In some aspects, the unsynchronized unlicensed access protocol may indicate a first ED threshold that is lower than a second ED threshold for synchronized unlicensed access. Alternatively or additionally, the unsynchronized unlicensed access protocol may indicate to restart a contention window after a contention-based deferral and/or a deferral that is based at least in part on a derived synchronization signal time boundary as further described below.

Based at least in part on measuring a power level below the ED threshold, the second device may start an LBT countdown timer and/or wait for an LBT countdown time duration (shown by reference number 520). To illustrate, the LBT countdown time duration 520 may be based at least in part on the IFS and contention back of time as shown in equation (1). In some aspects, and based at least in part on the first device using the licensed access protocol to transmit the first licensed access transmission 502, the second device may infer that a time associated with a transition from a measurement power level satisfying an ED threshold to failing to satisfy the ED threshold is associated with a synchronization signal time boundary. That is, the second device may drive the synchronization signal time boundary based at least in part on the power level transition. At an end of the LBT countdown, the second device may begin transmission of the second unlicensed access transmission 516. In some aspects, the unsynchronized unlicensed access protocol may specify to complete transmission of the second unlicensed access transmission 516 based at least in part on the calculated synchronization period (e.g., before the third synchronization signal time boundary 504-3). By completing transmission of the second unlicensed access transmission 516 based at least in part on the calculated synchronization period, the second device may free the shared portion of spectrum before the third synchronization signal time boundary 504-3 such that the first device may transmit a second licensed access transmission 522 at the third synchronization signal time boundary 504-3 without a collision from an unlicensed access transmission from the second device. Alternatively or additionally, the second device may use the derived synchronization period (e.g., one or more time boundaries associated with the synchronization period and/or a time duration synchronization period) to synchronize additional unlicensed access transmissions.

The example 524 shown by FIG. 5B includes the first licensed access transmission 502 generated by the first device based at least in part on a licensed access protocol and the time boundaries associated with the first device receiving a synchronization signal (e.g., the first synchronization signal time boundary 504-1, the second synchronization time boundary 504-2, the third synchronization signal time boundary 504-3, the first time slot time boundary 506-2, the second time slot time boundary 506-2, a third time slot time boundary 506-3, and the fourth time slot time boundary 506-4). In the example 524, the first device may synchronize transmission of the first licensed access transmission 502 based at least in part on the first synchronization signal time boundary 504-1.

The example 524 also includes the first unlicensed access transmission 508 generated by the second device based at least in part on using the unsynchronized unlicensed protocol access. Accordingly, the second device may lack information about the synchronization signal time boundary 504-1 and transmit the first unlicensed access transmission after performing a CCA procedure (e.g., a single CCA procedure, multiple CCA procedures, and/or as part of an LBT procedure) as shown by reference number 510 during the time duration 512. Based at least in part on the unsynchronized unlicensed access, a portion of the first licensed access transmission 502 and a portion of the first unlicensed access transmission 508 may collide, as shown by reference number 514.

As shown by the example 524, the second device may determine to transmit a third unlicensed access transmission 526 that is a new transmission. Based at least in part on the equation (1) and/or inferring a synchronization signal time boundary from transitioning power levels, the second device may defer transmission of the third unlicensed access transmission 526 based at least in part on a minimum time duration 528. That is, the unsynchronized unlicensed access protocol may indicate that the second device may restart an LBT procedure after the minimum time duration. Accordingly, at the expiration of the minimum time duration 528, the second device may restart an LBT countdown timer as shown by reference number 530 and, at expiration of the LBT countdown timer, begin transmission of the third unlicensed access transmission 526.

By deriving a synchronization signal boundary and/or deriving a synchronization period, a device communicating based at least in part on using an unsynchronized unlicensed access protocol may synchronize an unlicensed access transmission with a licensed access transmission. Synchronizing unlicensed access with licensed access may reduce the occurrence of collisions in shared spectrum, improve capacity, improve signal quality, reduce recovery errors, increase data throughput, and/or reduce data transfer latencies.

As indicated above, FIGS. 5A and 5B are provided as examples. Other examples may differ from what is described with regard to FIGS. 5A and 5B.

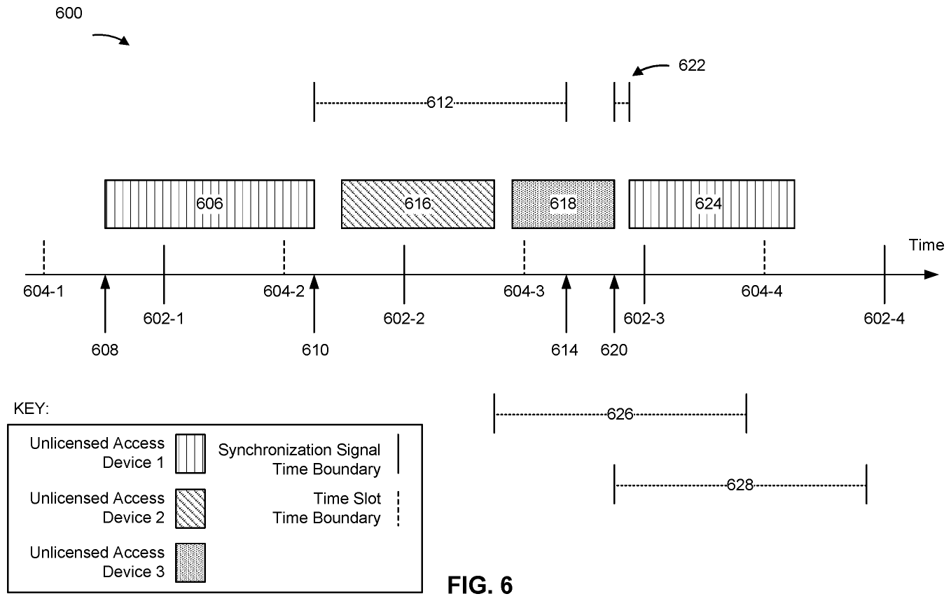

FIG. 6 is a diagram illustrating an example 600 of an unsynchronized unlicensed access protocol, in accordance with the present disclosure. In some aspects, the unsynchronized unlicensed access protocol may be associated with accessing a portion of spectrum that is allocated to both licensed access and unlicensed access, such as a first portion of spectrum within a millimeter wave band, a second portion of spectrum above the millimeter wave band, and/or a third portion of spectrum below a millimeter wave band. The unsynchronized unlicensed access protocol shown by the example 600 may alternatively be referred to as an unlicensed access protocol, and may be used in combination with the first example 500 and/or the second example 524 as described with regard to FIGS. 5A and 5B. At least some aspects of the unsynchronized unlicensed access protocol shown by the example 600 may be specified by a communication standard.

In some aspects, an unsynchronized unlicensed access protocol may specify a minimum time delay between two new transmissions by a device (e.g., the network node 110 and/or the UE 120). Alternatively or additionally, a primary network node may configure the device with the minimum time delay. To illustrate, the example 600 shows multiple unlicensed access transmissions associated with different devices. Unlicensed access transmissions by a first device are shown in the example 600 through the use of a vertical striped pattern, unlicensed access transmissions by a second device are shown through the use of a diagonal striped pattern, and unlicensed access transmissions by a third device are shown through the use of a dotted pattern. For reference, the example 600 also shows a first synchronization signal time boundary 602-1, a second synchronization time boundary 602-2, a third synchronization signal time boundary 602-3, a first time slot time boundary 604-1, a second time slot time boundary 604-2, a third time slot time boundary 604-3, and a fourth time slot time boundary 604-4 that may be based at least in part on a synchronization signal. However, these time boundaries may be unknown to the first device, the second device, and the third device discussed with regard to the example 600 based at least in part on the devices accessing the portion of spectrum using the unsynchronized unlicensed access protocol.

The first device may transmit a first unlicensed access transmission 606 at a first time 608 that may be an arbitrary time. In some aspects, the first device may transmit the first unlicensed access transmission 606 after performing a CCA procedure that clears as further described with regard to FIG. 5A. The first device may complete transmission of the first unlicensed access transmission 606 at a second time 610. At the second time 610 and after the completion of the first unlicensed access transmission 606, the first device may refrain from transmitting a new unlicensed access transmission for at least a first minimum time duration 612 that begins at the second time 610 and ends at a third time 614. During the first minimum time duration 612 and as shown by the example 600, the second device may transmit at least a portion of a second unlicensed access transmission 616 using the unsynchronized unlicensed access protocol and/or the third device may transmit at least a portion of a third unlicensed access transmission 618 using the unsynchronized unlicensed access protocol.

In some aspects, a primary network node may configure the first device with the first minimum time duration 612. For example, the primary network node may be implemented as an access point that services the first device, the second device, and the third device. Alternatively or additionally, the first device, the second device, and the third device may be implemented as a client device and/or a UE serviced by the access point. In some aspects, the primary network node may configure each device with a respective minimum time duration to synchronize unlicensed access transmissions to mitigate collisions. Alternatively or additionally, the primary network node may be aware of the synchronization signal time boundary and configure each device with a respective minimum time duration to synchronize an unlicensed access transmission with a licensed access transmission to mitigate collisions.

To illustrate, the first device may refrain from transmitting another (new) unlicensed access transmission during the first minimum time duration 612. At the third time 614, the first device may perform a CCA procedure and detect a first power level in the shared portion of spectrum that satisfies an ED threshold. As shown by the example 600, the detected first power level may be based at least in part on the third unlicensed access transmission 618. Based at least in part on detecting the first power level, the first device may defer transmitting a new unlicensed access transmission.

At a fourth time 620, the first device may detect a second power level in the shared portion of spectrum that fails to satisfy the ED threshold. The first device may begin an LBT countdown as shown by reference number 622 and, upon completion of the LBT countdown, begin transmission of a fourth unlicensed transmission 624. In some aspects, the unsynchronized unlicensed access protocol may indicate that self-deferral is disallow unless the self-deferral is based at least in part on ensuring a minimum time between DIFS. “Self-deferral” may denote a device delaying a transmission based at least in part on an operating condition at the device and not based on detected contentions as shown by the example 600. In some aspects, a self-deferral may result in an unlicensed access transmission that collides with a licensed access transmission. To mitigate collisions, the unsynchronized unlicensed access protocol may alternatively or additionally indicate that access probes transmitted by a UE (e.g., a client) are disallowed. Accordingly, the first device may begin transmission of the fourth unlicensed transmission 624 at the end of the LBT countdown instead of deferring transmission to a later point in time.

The second device may perform a similar procedure based at least in part on a second minimum time duration 626 (e.g., configured by a primary network node) and refrain from transmitting at least during the second minimum time duration 626. Alternatively or additionally, the third device may refrain from transmitting during at least a minimum time duration 628 that may also be configured by the primary network node.

A primary network node may configure a minimum time delay for a device that is communicating in shared spectrum using an unsynchronized unlicensed access protocol. By configuring the minimum time delay, the primary network node may synchronize an unlicensed access transmission with a licensed access transmission and/or another unlicensed access transmission. Synchronizing unlicensed access with licensed access and/or additional unlicensed access may reduce the occurrence of collisions in shared spectrum, improve capacity, improve signal quality, reduce recovery errors, increase data throughput, and/or reduce data transfer latencies.

As indicated above, FIG. 6 is provided as an example. Other examples may differ from what is described with regard to FIG. 6.

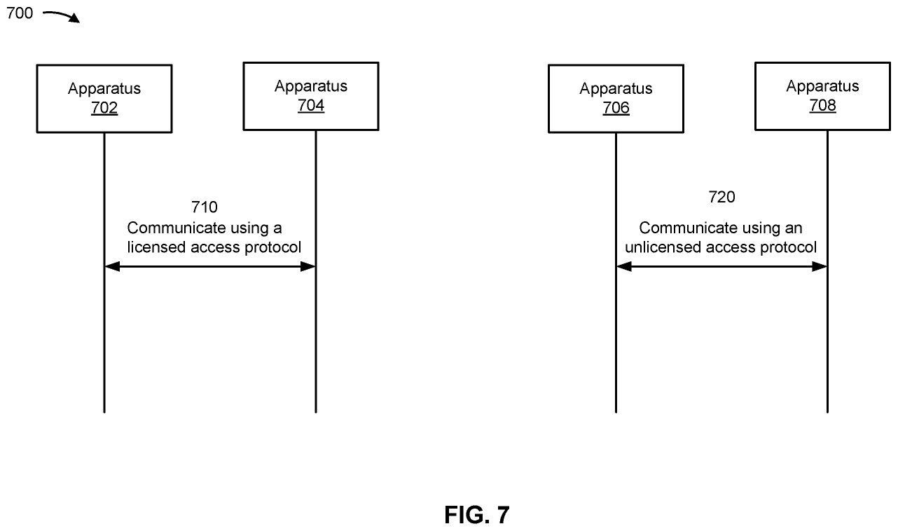

FIG. 7 is a diagram illustrating an example 700 of a wireless communication process between a first pair of apparatuses (shown as apparatus 702 and apparatus 704) and a second pair of apparatuses (shown as apparatus 706 and apparatus 708), in accordance with the present disclosure. In some aspects, the apparatus 702 and apparatus 704 may communicate with one another based at least in part on using a licensed access protocol associated with a frequency band that is allocated to licensed access and unlicensed access. Alternatively or additionally, the apparatus 706 and apparatus 708 may communicate with one another based at least in part on using an unlicensed access protocol (e.g., a synchronized unlicensed access protocol or an unsynchronized unlicensed access protocol) associated with the same frequency band that is allocated to licensed access and unlicensed access. The apparatus 702, the apparatus 704, the apparatus 706, and the apparatus 708 may be included in any combination of devices, such as any combination of a network node (e.g., the network node 110) and/or a UE (e.g., the UE 120).

As shown by reference number 710, a first apparatus 702 may communicate with a second apparatus 704 based at least in part on using a licensed access protocol associated with a frequency band that is allocated to licensed access and unlicensed access. To illustrate, the first apparatus 702 and/or the second apparatus 704 may receive a synchronization signal from an external device. As one non-limiting example, the synchronization signal may be a GNSS synchronization signal. The first apparatus 702 and/or the second apparatus 704 may communicate with one another based at least in part on using TDM that uses a time boundary associated with the synchronization signal. In some aspects, the TDM used by the first apparatus 702 and/or the second apparatus 704 (e.g., as specified by the licensed access protocol) may align a synchronization signal time boundary associated with the synchronization signal with a slot time boundary as further described with regard to FIGS. 3A and 3B. Alternatively or additionally, the TDM may partition a time duration between synchronization signal time boundaries into multiple time slots.

In some aspects, the first apparatus 702 and/or the second apparatus 704 may transmit a communication (e.g., a downlink communication or an uplink communication) without performing a CCA procedure. In other aspects, the first apparatus 702 and/or the second apparatus 704 may perform the CCA procedure (e.g., optionally or as instructed by the licensed access protocol) and transmit the communication based at least in part on the CCA procedure clearing.

In some aspects, the first apparatus 702 and/or the second apparatus 704 may communicate with one another based at least in part on starting transmission of a communication at a synchronization signal time boundary. Starting transmission at the synchronization signal boundary may include delaying transmission of the communication until the synchronization signal time boundary.

As shown by reference number 720, a third apparatus 706 may communicate with a fourth apparatus 708 based at least in part on using an unlicensed access protocol (e.g., a synchronized unlicensed access protocol or an unsynchronized unlicensed access protocol) associated with the same frequency band used by the apparatus 702 and/or the apparatus 704. In some aspects, the same frequency band may be allocated to licensed access and unlicensed access. As one example, the third apparatus 706 may communicate with the fourth apparatus 708 based at least in part on using a synchronized unlicensed access protocol. As another example, the third apparatus 706 may communicate with the fourth apparatus 708 based at least in part on using an unsynchronized unlicensed access protocol.

Based at least in part on using a synchronized unlicensed access protocol, the third apparatus 706 and/or the fourth apparatus 708 may receive a synchronization signal from an external device (e.g., a GNSS synchronization signal), and communicate with one another based at least in part on receiving the synchronization signal and/or based at least in part on a synchronization signal time boundary associated with the synchronization signal. As one example, the third apparatus 706 and/or the fourth apparatus 708 may perform a CCA procedure prior to transmitting a communication, and delay performing the CCA procedure until the synchronization signal time boundary. As further described herein, transmitting the communication may be conditional and/or based at least in part on the CCA procedure clearing. Alternatively or additionally, the third apparatus 706 and/or the fourth apparatus 708 may refrain from transmitting an access probe until receiving the synchronization signal to mitigate collisions. In some aspects, and as part of communicating using the synchronized unlicensed access protocol, the third apparatus 706 and/or the fourth apparatus 708 may transmit a beacon based at least in part on using an air interface resource specified by a communication standard, such as a specified time slot that is based at least in part on the synchronization signal time boundary, a specified frequency band, and/or a specified frequency sub-band (e.g., a primary channel and/or a control channel).

The third apparatus 706 and/or the fourth apparatus 708 may perform a CCA procedure based at least in part on using a frequency band and/or a frequency sub-band specified by a communication standard. That is, the third apparatus 706 and/or the fourth apparatus 708 may measure a power level within the frequency band and/or the frequency sub-band specified by the communication standard. To illustrate, the frequency sub-band may be associated with a primary channel and/or a control channel used by another device to transmit a reserve signal. Alternatively or additionally, the third apparatus 706 and/or the fourth apparatus 708 may transmit, prior to transmitting a communication to the other apparatus, a reserve signal based at least in part on using the primary channel and/or the control channel.

In some aspects, and based at least in part on using the synchronized unlicensed access protocol, the third apparatus 706 and/or the fourth apparatus 708 may perform a second CCA procedure, such as when the third apparatus 706 and/or the fourth apparatus 708 identifies that a first CCA procedure detects energy in the frequency band and/or frequency sub-band. In some aspects, the third apparatus 706 and/or the fourth apparatus 708 may delay performing the second CCA procedure until a second synchronization signal time boundary.

Based at least in part on using an unsynchronized unlicensed access protocol, the third apparatus 706 and/or the fourth apparatus 708 may transmit a first communication to the other apparatus, and defer transmission of a second communication based at least in part on a derived synchronization signal time boundary. As one example, the third apparatus 706 and/or the fourth apparatus 708 may receive a configuration parameter associated with the unsynchronized unlicensed access protocol from a primary network node, and calculate the derived synchronization signal time boundary based at least in part on the configuration parameter, such as that described with regard to equation (1). Alternatively or additionally, the third apparatus 706 and/or the fourth apparatus 708 may calculate a synchronization period between a first derived synchronization signal time boundary and a second derived synchronization signal time boundary. For example, the third apparatus 706 and/or the fourth apparatus 708 may receive, as the configuration parameter, one or more of an energy threshold, a contention window size, a listen-before-talk configuration parameter, an interframe space length, a backoff configuration, and/or a synchronization period. However, other examples may include alternate or additional unlicensed access protocol configuration parameters. Calculating the synchronization period may be based at least in part on an IFS length (e.g., a size or time duration) and/or DIFS.

Based at least in part on using an unsynchronized unlicensed access protocol, the third apparatus 706 and/or the fourth apparatus 708 may perform a CCA procedure (e.g., prior to transmission of a communication) as further described with regard to FIGS. 5A, 5B, and 6. In some aspects, the third apparatus 706 and/or the fourth apparatus 708 may detect a contention. That is, the CCA procedure may indicate that a detected energy level satisfies an ED threshold. Accordingly, the third apparatus 706 and/or the fourth apparatus 708 may defer transmission of a communication based at least in part on detecting the contention. In some aspects, the CCA procedure may be based at least in part on a first ED threshold that is lower than a second ED threshold associated with synchronized unlicensed access.

In some aspects, the unsynchronized unlicensed access protocol indicates to complete transmission of a communication by a derived synchronization signal time boundary. Accordingly, the third apparatus 706 and/or the fourth apparatus 708 may communicate with one another based at least in part on completing a transmission by a derived synchronization signal time boundary.

Based at least in part on using an unsynchronized unlicensed access protocol, the third apparatus 706 and/or the fourth apparatus 708 may restart a minimum time duration (e.g., associated with transmitting a new transmission) after completing transmission of a communication, as further described with regard to FIGS. 5A, 5B, and 6. Alternatively or additionally, the third apparatus 706 and/or the fourth apparatus 708 may defer transmission of a new communication based at least in part on the minimum time duration. In some aspects, the third apparatus 706 and/or the fourth apparatus 708 may receive an indication of a minimum time duration from a primary network node.

In some aspects, the unsynchronized unlicensed access protocol may indicate that self-deferral by an apparatus is disallowed. Accordingly, the third apparatus 706 and/or the fourth apparatus 708 may refrain from deferring transmission based at least in part on self-deferral. Alternatively or additionally, the unsynchronized unlicensed access protocol may indicate that transmission of an access probe is disallowed. Accordingly, the third apparatus 706 and/or the fourth apparatus 708 may refrain from transmitting an access probe, such as when the third apparatus 706 and/or the fourth apparatus 708 are at least part of a UE.

Coordinating licensed access and unlicensed access to a same portion of spectrum may increase a capacity of a wireless network and reduce interference observed by a receiver. The reduced interference may increase signal quality, reduce recovery errors, increase data throughput, and/or reduce data transfer latencies.

As indicated above, FIG. 7 is provided as an example. Other examples may differ from what is described with regard to FIG. 7.

FIG. 8 is a diagram illustrating an example process 800 performed, for example, by an apparatus, in accordance with the present disclosure. Example process 800 is an example where the apparatus (e.g., the network node 110 and/or the UE 120) performs operations associated with sharing a frequency band between licensed access and unlicensed access.

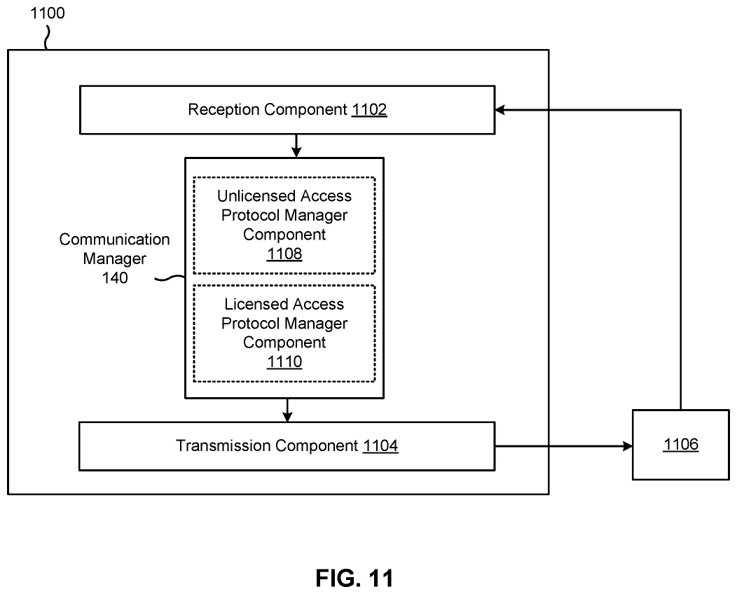

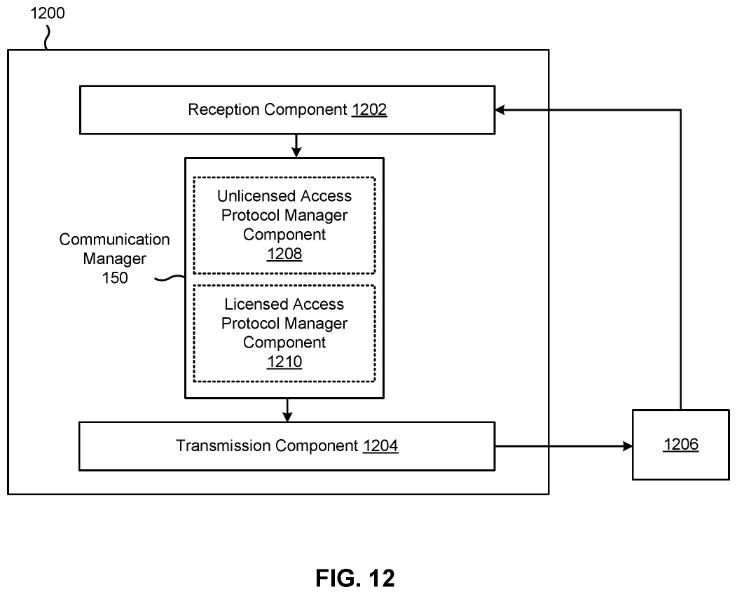

As shown in FIG. 8, in some aspects, process 800 may include receiving a synchronization signal from an external device (block 810). For example, the apparatus (e.g., using communication manager 140 and/or reception component 1102 depicted in FIG. 11, and/or using communication manager 150 and/or reception component 1202, depicted in FIG. 12) may receive a synchronization signal from an external device, as described above.

As further shown in FIG. 8, in some aspects, process 800 may include communicating in a wireless network using a licensed access protocol that is based at least in part on TDM that uses a time boundary associated with the synchronization signal, the communicating being based at least in part on a frequency band that is allocated to a licensed access mode and an unlicensed access mode (block 820). For example, the apparatus (e.g., using communication manager 140 and/or licensed access protocol manager component 1110, depicted in FIG. 11, and/or using communication manager 150 and/or licensed access protocol manager component 1210, depicted in FIG. 12) may communicate in a wireless network using a licensed access protocol that is based at least in part on TDM that uses a time boundary associated with the synchronization signal, the communicating being based at least in part on a frequency band that is allocated to a licensed access mode and an unlicensed access mode, as described above.

Process 800 may include additional aspects, such as any single aspect or any combination of aspects described below and/or in connection with one or more other processes described elsewhere herein.

In a first aspect, the synchronization signal is a GNSS synchronization signal.

In a second aspect, the licensed access protocol is based at least in part on aligning a synchronization signal time boundary associated with the synchronization signal with a slot time boundary of the licensed access mode.

In a third aspect, the TDM partitioning includes at least two slots between two sync time boundaries.

In a fourth aspect, communicating in the wireless network includes transmitting a communication without performing a CCA procedure.

In a fifth aspect, the communication includes a downlink communication, or an uplink communication.

In a sixth aspect, communicating in the wireless network includes performing a CCA procedure, and transmitting an uplink communication to a network node based at least in part on the CCA procedure clearing.

In a seventh aspect, communicating in the wireless network includes transmitting a communication based at least in part on starting transmission of the communication at a synchronization signal time boundary.

In an eighth aspect, transmitting the communication includes delaying transmission of the communication until the synchronization signal time boundary.

In a ninth aspect, the apparatus is at least part of a network node.

In a tenth aspect, the apparatus is at least part of a UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by an apparatus, in accordance with the present disclosure. Example process 900 is an example where the apparatus (e.g., the network node 110 and/or the UE 120) performs operations associated with sharing a frequency band between licensed access and unlicensed access.

As shown in FIG. 9, in some aspects, process 900 may include receiving a synchronization signal from an external device (block 910). For example, the apparatus (e.g., using communication manager 140 and/or reception component 1102 depicted in FIG. 11, or using communication manager 150 and/or reception component 1202, depicted in FIG. 12) may receive a synchronization signal from an external device, as described above.

As further shown in FIG. 9, in some aspects, process 900 may include communicating in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode (block 920). For example, the apparatus (e.g., using communication manager 140 and/or unlicensed access protocol manager component 1108 depicted in FIG. 11, and/or using communication manager 150 and/or unlicensed access protocol manager component 1108, depicted in FIG. 12) may communicate in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode, as described above.

Process 900 may include additional aspects, such as any single aspect or any combination of aspects described below and/or in connection with one or more other processes described elsewhere herein.

In a first aspect, the synchronization signal includes a GNSS synchronization signal.

In a second aspect, communicating in the wireless network includes transmitting a communication, and process 900 includes performing a CCA procedure prior to transmitting the communication.

In a third aspect, performing the CCA procedure includes delaying performing the CCA procedure until the synchronization signal time boundary

In a fourth aspect, transmitting the communication includes transmitting the communication based at least in part on the CCA procedure clearing.

In a fifth aspect, performing the CCA procedure includes performing the CCA procedure based at least in part on a frequency sub-band specified by a communication standard.

In a sixth aspect, the CCA procedure is a first CCA procedure, the synchronization signal time boundary is a first synchronization signal time boundary, and process 900 includes identifying that the first CCA procedure indicates that energy is detected in the frequency band, and delaying performing a second CCA procedure until a second synchronization signal time boundary.

In a seventh aspect, communicating in the wireless network includes transmitting a communication, and process 900 includes transmitting, prior to transmitting the communication, a reserve signal based at least in part on using a primary channel.

In an eighth aspect, process 900 includes refraining from transmitting an access probe until receiving the synchronization signal.

In a ninth aspect, process 900 includes transmitting a beacon based at least in part on using an air interface resource specified by a communication standard.

In a tenth aspect, the apparatus is at least part of a network node.

In an eleventh aspect, the apparatus is at least part of a UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by an apparatus, in accordance with the present disclosure. Example process 1000 is an example where the apparatus (e.g., the network node 110 and/or the UE 120) performs operations associated with sharing a frequency band between licensed access and unlicensed access.

As shown in FIG. 10, in some aspects, process 1000 may include transmitting a first communication based at least in part on using an unsynchronized unlicensed access protocol that is associated with a frequency band that is allocated to a licensed access mode and an unlicensed access mode (block 1010). For example, the apparatus (e.g., using communication manager 140 and/or reception component 1102 depicted in FIG. 11, and/or using communication manager 150 and/or reception component 1202, depicted in FIG. 12) may transmit a first communication based at least in part on using an unsynchronized unlicensed access protocol that is associated with a frequency band that is allocated to a licensed access mode and an unlicensed access mode, as described above.

As further shown in FIG. 10, in some aspects, process 1000 may include deferring, based at least in part on the unsynchronized unlicensed access protocol, transmission of a second communication based at least in part on a derived synchronization signal time boundary (block 1020). For example, the apparatus (e.g., using communication manager 140 and/or unlicensed access protocol manager component 1108 depicted in FIG. 11, and/or using communication manager 150 and/or unlicensed access protocol manager component 1108, depicted in FIG. 12) may defer, based at least in part on the unsynchronized unlicensed access protocol, transmission of a second communication based at least in part on a derived synchronization signal time boundary, as described above.

Process 1000 may include additional aspects, such as any single aspect or any combination of aspects described below and/or in connection with one or more other processes described elsewhere herein.

In a first aspect, process 1000 includes receiving a configuration parameter associated with the unsynchronized unlicensed access protocol, and calculating the derived synchronization signal time boundary based at least in part on the configuration parameter. For example, the configuration parameter may include one or more of an energy threshold, a contention window size, a listen-before-talk configuration parameter, an interframe space length, a backoff configuration, and/or a synchronization period. However, other examples may include alternate or additional unlicensed access protocol configuration parameters.

In a second aspect, the derived synchronization signal time boundary is a first derived synchronization signal time boundary, and process 1000 includes calculating a synchronization period between the first derived synchronization signal time boundary and a second derived synchronization signal time boundary based at least in part on a distributed coordinated function interframe space.

In a third aspect, the unsynchronized unlicensed access protocol indicates that self-deferral by the apparatus is disallowed.

In a fourth aspect, process 1000 includes restarting a minimum time duration after completing transmission of the second communication.

In a fifth aspect, the apparatus is at least part of a UE, and the unsynchronized unlicensed access protocol indicates that transmission of an access probe is disallowed.

In a sixth aspect, process 1000 includes performing a CCA procedure, and detecting, as part of the CCA procedure, a contention. In some aspects, deferring transmission of the second communication is based at least in part on detecting the contention.

In a seventh aspect, process 1000 includes completing transmission of the second communication based at least in part on the derived synchronization signal time boundary.

In an eighth aspect, performing the CCA procedure is based at least in part on a first energy detected threshold that is lower than a second energy detected threshold associated with synchronized unlicensed access.

In a ninth aspect, the apparatus is at least part of a UE, and process 1000 includes receiving an indication of a minimum time duration from a primary network node. In some aspects, deferring transmission of the second communication is based at least in part on the minimum time duration.

In a tenth aspect, the apparatus is at least part of a network node.

In an eleventh aspect, the apparatus is at least part of a UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a first apparatus (e.g., a network node 110 and/or a UE 120), another apparatus (e.g., the network node 110 and/or the UE 120) may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of an unlicensed access protocol manager component 1108 and/or a licensed access protocol manager component 1110, among other examples.

In some aspects, the apparatus 1100 may be configured to perform one or more operations described herein in connection with FIGS. 3A-10. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the apparatus described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the apparatus described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the apparatus described in connection with FIG. 2. In some aspects, the transmission component 1104 may be co-located with the reception component 1102 in a transceiver.

The reception component 1102 may receive a synchronization signal from an external device. The licensed access protocol manager component 1110 may communicate in a wireless network, by way of the reception component 1102 and/or the transmission component 1104, using a licensed access protocol that is based at least in part on TDM that uses a time boundary associated with the synchronization signal, the communicating being based at least in part on a frequency band that is allocated to a licensed access mode and an unlicensed access mode.

The reception component 1102 may receive a synchronization signal from an external device. The unlicensed access protocol manager component 1108 may communicate in a wireless network, by way of the reception component 1102 and/or the transmission component 1104, using a synchronized unlicensed access protocol that is based at least in part on a synchronization signal time boundary associated with the synchronization signal, the communicating being based at least in part on a frequency band that is allocated to a licensed access mode and an unlicensed access mode.

The unlicensed access protocol manager component 1108 may refrain from transmitting an access probe until receiving the synchronization signal.

The transmission component 1104 may transmit a first communication based at least in part on using an unsynchronized unlicensed access protocol that is associated with a frequency band that is allocated to a licensed access mode and an unlicensed access mode. The unlicensed access protocol manager component 1108 may defer, based at least in part on the unsynchronized unlicensed access protocol, transmission of a second communication based at least in part on a derived synchronization signal time boundary.

The unlicensed access protocol manager component 1108 may receive, by way of the reception component 1102, a configuration parameter associated with the unsynchronized unlicensed access protocol. Alternatively or additionally, the unlicensed access protocol manager component 1108 may calculate the derived synchronization signal time boundary based at least in part on the configuration parameter. In some aspects, the unlicensed access protocol manager component 1108 may restart a minimum time duration after completing transmission of the second communication.

The unlicensed access protocol manager component 1108 may perform a CCA procedure. In some aspects, the unlicensed access protocol manager component 1108 may detect, as part of the CCA procedure, a contention. In some aspects, deferring transmission of the second communication is based at least in part on detecting the contention. The unlicensed access protocol manager component 1108 may complete transmission of the second communication based at least in part on the derived synchronization signal time boundary.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a first apparatus (e.g., a network node 110 and/or a UE 120), or another apparatus (e.g., the network node 110 and/or the UE 120) may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include one or more of an unlicensed access protocol manager component 1208 and/or a licensed access protocol manager component 1210, among other examples.

In some aspects, the apparatus 1200 may be configured to perform one or more operations described herein in connection with FIGS. 3A-10. Additionally, or alternatively, the apparatus 1200 may be configured to perform one or more processes described herein, such as process 800 of FIG. 8, process 900 of FIG. 9, process 1000 of FIG. 10, or a combination thereof. In some aspects, the apparatus 1200 and/or one or more components shown in FIG. 12 may include one or more components of the apparatus described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the apparatus described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the apparatus described in connection with FIG. 2. In some aspects, the transmission component 1204 may be co-located with the reception component 1202 in a transceiver.

The reception component 1202 may receive a synchronization signal from an external device. The licensed access protocol manager component 1210 may communicate in a wireless network using a licensed access protocol that is based at least in part on TDM that uses a time boundary associated with the synchronization signal, the communicating being based at least in part on a frequency band that is allocated to a licensed access mode and an unlicensed access mode.

The reception component 1202 may receive a synchronization signal from an external device. The unlicensed access protocol manager component 1208 may communicate in a wireless network, by way of the reception component 1202 and/or the transmission component 1204, using a synchronized unlicensed access protocol that is based at least in part on a synchronization signal time boundary associated with the synchronization signal, the communicating being based at least in part on a frequency band that is allocated to a licensed access mode and an unlicensed access mode.

The unlicensed access protocol manager component 1208 may refrain from transmitting an access probe until receiving the synchronization signal. Alternatively or additionally, the unlicensed access protocol manager component 1208 may transmit, by way of the transmission component 1204, a beacon based at least in part on using an air interface resource specified by a communication standard.

The transmission component 1204 may transmit a first communication based at least in part on using an unsynchronized unlicensed access protocol that is associated with a frequency band that is allocated to a licensed access mode and an unlicensed access mode. The unlicensed access protocol manager component 1208 may defer, based at least in part on the unsynchronized unlicensed access protocol, transmission of a second communication based at least in part on a derived synchronization signal time boundary.

The unlicensed access protocol manager component 1208 may receive, by way of the reception component 1202, a configuration parameter associated with the unsynchronized unlicensed access protocol. Alternatively or additionally, the unlicensed access protocol manager component 1208 may calculate the derived synchronization signal time boundary based at least in part on the configuration parameter. In some aspects, the unlicensed access protocol manager component 1208 may restart a minimum time duration after completing transmission of the second communication.

The unlicensed access protocol manager component 1208 may perform a CCA procedure. In some aspects, the unlicensed access protocol manager component 1208 may detect, as part of the CCA procedure, a contention. In some aspects, deferring transmission of the second communication is based at least in part on detecting the contention.

Alternatively or additionally, the unlicensed access protocol manager component 1208 may complete transmission of the second communication based at least in part on the derived synchronization signal time boundary.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by an apparatus, comprising: receiving a synchronization signal from an external device; and communicating in a wireless network using a licensed access protocol that is based at least in part on time division multiplexing (TDM) that uses a time boundary associated with the synchronization signal, the communicating being based at least in part on a frequency band that is allocated to a licensed access mode and an unlicensed access mode.

Aspect 2: The method of Aspect 1, wherein the synchronization signal is a global navigation satellite system (GNSS) synchronization signal.

Aspect 3: The method of Aspect 1 or Aspect 2, wherein the licensed access protocol is based at least in part on aligning a synchronization signal time boundary associated with the synchronization signal with a slot time boundary of the licensed access mode.

Aspect 4: The method of Aspect 3, wherein the TDM partitioning comprises at least two slots between two sync time boundaries.

Aspect 5: The method of any one of Aspects 1-4, wherein communicating in the wireless network comprises: transmitting a communication without performing a clear channel assessment procedure.

Aspect 6: The method of Aspect 5, wherein the communication comprises: a downlink communication, or an uplink communication.

Aspect 7: The method of any one of Aspects 1-4, wherein communicating in the wireless network comprises: performing a clear channel assessment procedure; and transmitting an uplink communication to a network node based at least in part on the clear channel assessment procedure clearing.

Aspect 8: The method of any one of Aspects 1-7, wherein communicating in the wireless network comprises: transmitting a communication based at least in part on starting transmission of the communication at a synchronization signal time boundary.

Aspect 9: The method of Aspect 8, wherein transmitting the communication comprises: delaying transmission of the communication until the synchronization signal time boundary.

Aspect 10: The method of any one of Aspects 1-9, wherein the apparatus is at least part of a network node.

Aspect 11: The method of any one of Aspects 1-9, wherein the apparatus is at least part of a user equipment (UE).

Aspect 12: A method of wireless communication performed by an apparatus, comprising: receiving a synchronization signal from an external device; and communicating in a wireless network using a synchronized unlicensed access protocol that is based at least in part on a synchronization signal time boundary associated with the synchronization signal, the communicating being based at least in part on a frequency band that is allocated to a licensed access mode and an unlicensed access mode.

Aspect 13: The method of Aspect 12, wherein the synchronization signal comprises a global navigation satellite system (GNSS) synchronization signal.

Aspect 14: The method of Aspect 12 or Aspect 13, wherein communicating in the wireless network comprises transmitting a communication, and the method further comprises: performing a clear channel assessment procedure prior to transmitting the communication.

Aspect 15: The method of Aspect 14, wherein performing the clear channel assessment procedure comprises: delaying performing the clear channel assessment procedure until the synchronization signal time boundary

Aspect 16: The method of Aspect 14 or Aspect 15, wherein transmitting the communication comprises: transmitting the communication based at least in part on the clear channel assessment procedure clearing.

Aspect 17: The method of any one of Aspects 14-16, wherein performing the clear channel assessment procedure comprises: performing the clear channel assessment procedure based at least in part on a frequency sub-band specified by a communication standard.

Aspect 18: The method of any one of Aspects 14-17, wherein the clear channel assessment procedure is a first clear channel assessment procedure, wherein the synchronization signal time boundary is a first synchronization signal time boundary, and the method further comprising: identifying that the first clear channel assessment procedure indicates that energy is detected in the frequency band; and delaying performing a second clear channel assessment procedure until a second synchronization signal time boundary.

Aspect 19: The method of any one of Aspects 12-18, wherein communicating in the wireless network comprises transmitting a communication, and the method further comprises: transmitting, prior to transmitting the communication, a reserve signal based at least in part on using a primary channel.

Aspect 20: The method of any one of Aspects 12-19, further comprising: refraining from transmitting an access probe until receiving the synchronization signal.

Aspect 21: The method of any one of Aspects 12-20, further comprising: transmitting a beacon based at least in part on using an air interface resource specified by a communication standard.

Aspect 22: The method of any one of Aspects 12-20, wherein the apparatus is at least part of a network node.

Aspect 23: The method of any one of Aspects 12-21, wherein the apparatus is at least part of a user equipment (UE).

Aspect 24: A method of wireless communication performed by an apparatus, comprising: transmitting a first communication based at least in part on using an unsynchronized unlicensed access protocol that is associated with a frequency band that is allocated to a licensed access mode and an unlicensed access mode; and deferring, based at least in part on the unsynchronized unlicensed access protocol, transmission of a second communication based at least in part on a derived synchronization signal time boundary.

Aspect 25: The method of Aspect 24, further comprising: receiving a configuration parameter associated with the unsynchronized unlicensed access protocol; and calculating the derived synchronization signal time boundary based at least in part on the configuration parameter.

Aspect 26: The method of Aspect 25, wherein the derived synchronization signal time boundary is a first derived synchronization signal time boundary, and the method further comprising: calculating a synchronization period between the first derived synchronization signal time boundary and a second derived synchronization signal time boundary based at least in part on a distributed coordinated function interframe space.

Aspect 27: The method of Aspect 25 or Aspect 26, wherein the configuration parameter comprises at least one of: an energy threshold, a contention window size, a listen-before-talk configuration parameter, an interframe space length, a backoff configuration, or a synchronization period

Aspect 28: The method of any one of Aspects 24-27, wherein the unsynchronized unlicensed access protocol indicates that self-deferral by the apparatus is disallowed.

Aspect 29: The method of any one of Aspects 24-28, further comprising: restarting a minimum time duration after completing transmission of the second communication.

Aspect 30: The method of any one of Aspects 24-29, wherein the apparatus is at least part of a user equipment (UE), and wherein the unsynchronized unlicensed access protocol indicates that transmission of an access probe is disallowed.

Aspect 31: The method of any one of Aspects 24-30, further comprising: performing a clear channel assessment procedure; and detecting, as part of the clear channel assessment procedure, a contention, wherein deferring transmission of the second communication is based at least in part on detecting the contention.

Aspect 32: The method of any one of Aspects 24-31, further comprising: completing transmission of the second communication based at least in part on the derived synchronization signal time boundary.

Aspect 33: The method of Aspect 31 or Aspect 32, wherein performing the clear channel assessment procedure is based at least in part on a first energy detected threshold that is lower than a second energy detected threshold associated with synchronized unlicensed access.

Aspect 34: The method of any one of Aspects 24-33, wherein the apparatus is at least part of a user equipment (UE), and the method further comprises: receiving an indication of a minimum time duration from a primary network node, wherein deferring transmission of the second communication is based at least in part on the minimum time duration.

Aspect 35: The method of any one of Aspects 24-29 and 31-33, wherein the apparatus is at least part of a network node.

Aspect 36: The method of any one of Aspects 24-34, wherein the apparatus is at least part of a user equipment (UE).

Aspect 37: An apparatus for wireless communication at a device, comprising one or more processors; one or more memories coupled with the one or more processors; and instructions stored in the memory and executable by the processors, individually or collectively, to cause the apparatus to perform the method of one or more of Aspects 1-11.

Aspect 38: An apparatus for wireless communication at a device, comprising one or more processors; one or more memories coupled with the one or more processors; and instructions stored in the memory and executable by the processors, individually or collectively, to cause the apparatus to perform the method of one or more of Aspects 12-23.

Aspect 39: An apparatus for wireless communication at a device, comprising one or more processors; one or more memories coupled with the one or more processors; and instructions stored in the memory and executable by the processors, individually or collectively, to cause the apparatus to perform the method of one or more of Aspects 24-36.

Aspect 40: A device for wireless communication, comprising a memory and one or more processors coupled to the memory, the one or more processors configured to perform the method of one or more of Aspects 1-11.

Aspect 41: A device for wireless communication, comprising a memory and one or more processors coupled to the memory, the one or more processors configured to perform the method of one or more of Aspects 12-23.

Aspect 42: A device for wireless communication, comprising a memory and one or more processors coupled to the memory, the one or more processors configured to perform the method of one or more of Aspects 24-36.

Aspect 43: An apparatus for wireless communication, comprising at least one means for performing the method of one or more of Aspects 1-11.

Aspect 44: An apparatus for wireless communication, comprising at least one means for performing the method of one or more of Aspects 12-23.

Aspect 45: An apparatus for wireless communication, comprising at least one means for performing the method of one or more of Aspects 24-36.

Aspect 46: A non-transitory computer-readable medium storing code for wireless communication, the code comprising instructions executable by a processor to perform the method of one or more of Aspects 1-11.

Aspect 47: A non-transitory computer-readable medium storing code for wireless communication, the code comprising instructions executable by a processor to perform the method of one or more of Aspects 12-23.

Aspect 48: A non-transitory computer-readable medium storing code for wireless communication, the code comprising instructions executable by a processor to perform the method of one or more of Aspects 24-36.

Aspect 49: A non-transitory computer-readable medium storing a set of instructions for wireless communication, the set of instructions comprising one or more instructions that, when executed by one or more processors of a device, cause the device to perform the method of one or more of Aspects 1-11.

Aspect 50: A non-transitory computer-readable medium storing a set of instructions for wireless communication, the set of instructions comprising one or more instructions that, when executed by one or more processors of a device, cause the device to perform the method of one or more of Aspects 12-23.

Aspect 51: A non-transitory computer-readable medium storing a set of instructions for wireless communication, the set of instructions comprising one or more instructions that, when executed by one or more processors of a device, cause the device to perform the method of one or more of Aspects 24-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed:

1. An apparatus for wireless communication at an apparatus, comprising:
one or more memories; and
one or more processors, coupled to the one or more memories, configured, individually or collectively, to cause the apparatus to:
receive a synchronization signal from an external device; and
communicate in a wireless network using a licensed access protocol that is based at least in part on time division multiplexing (TDM) that uses a time boundary associated with the synchronization signal, the one or more processors configured to cause the apparatus to communicate based at least in part on a frequency band that is allocated to a licensed access mode and an unlicensed access mode.

2. The apparatus of claim 1, wherein the synchronization signal is a global navigation satellite system (GNSS) synchronization signal.

3. The apparatus of claim 1, wherein the licensed access protocol is based at least in part on aligning a synchronization signal time boundary associated with the synchronization signal with a slot time boundary of the licensed access mode.

4. The apparatus of claim 1, wherein the one or more processors, to cause the apparatus to communicate in the wireless network, are configured to cause the apparatus to:
transmit a communication without performing a clear channel assessment procedure.

5. The apparatus of claim 1, wherein the one or more processors, to cause the apparatus to communicate in the wireless network, are configured to cause the apparatus to:
perform a clear channel assessment procedure; and
transmit an uplink communication to a network node based at least in part on the clear channel assessment procedure clearing.

6. The apparatus of claim 1, wherein the one or more processors, to cause the apparatus to communicate in the wireless network, are configured to cause the apparatus to:
transmit a communication based at least in part on starting transmission of the communication at a synchronization signal time boundary.

7. The apparatus of claim 6, wherein the one or more processors, to cause the apparatus to transmit the communication, are configured to cause the apparatus to:
delay transmission of the communication until the synchronization signal time boundary.

8. An apparatus for wireless communication at an apparatus, comprising:
one or more memories; and
one or more processors, coupled to the one or more memories, configured, individually or collectively, to cause the apparatus to:
receive a synchronization signal from an external device; and
communicate in a wireless network using a synchronized unlicensed access protocol that is based at least in part on a synchronization signal time boundary associated with the synchronization signal, the one or more processors configured to cause the apparatus to communicate based at least in part on a frequency band that is allocated to a licensed access mode and an unlicensed access mode.

9. The apparatus of claim 8, wherein the synchronization signal comprises a global navigation satellite system (GNSS) synchronization signal.

10. The apparatus of claim 8, wherein the one or more processors, to cause the apparatus to communicate in the wireless network, are configured to cause the apparatus to transmit a communication, and
wherein the one or more processors are further configured to cause the apparatus to:
perform a clear channel assessment procedure prior to transmitting the communication.

11. The apparatus of claim 10, wherein the one or more processors, to cause the apparatus to perform the clear channel assessment procedure, are configured to cause the apparatus to:
delay performing the clear channel assessment procedure until the synchronization signal time boundary.

12. The apparatus of claim 10, wherein the one or more processors, to cause the apparatus to transmit the communication, are configured to cause the apparatus to:
transmit the communication based at least in part on the clear channel assessment procedure clearing.

13. The apparatus of claim 10, wherein the one or more processors, to cause the apparatus to perform the clear channel assessment procedure, are configured to cause the apparatus to:
perform the clear channel assessment procedure based at least in part on a frequency sub-band specified by a communication standard.

14. The apparatus of claim 8, wherein the one or more processors, to cause the apparatus to communicate in the wireless network, are configured to cause the apparatus to transmit a communication, and
wherein the one or more processors are further configured to cause the apparatus to:
transmit, prior to transmitting the communication, a reserve signal based at least in part on using a primary channel.

15. The apparatus of claim 8, wherein the one or more processors are further configured to cause the apparatus to:
refrain from transmitting an access probe until receiving the synchronization signal.

16. The apparatus of claim 8, wherein the one or more processors are further configured to cause the apparatus to:
transmit a beacon based at least in part on using an air interface resource specified by a communication standard.

17. An apparatus for wireless communication at an apparatus, comprising:
one or more memories; and
one or more processors, coupled to the one or more memories, configured, individually, or collectively, to cause the apparatus to:
transmit a first communication based at least in part on using an unsynchronized unlicensed access protocol that is associated with a frequency band that is allocated to a licensed access mode and an unlicensed access mode; and
defer, based at least in part on the unsynchronized unlicensed access protocol, transmission of a second communication based at least in part on a derived synchronization signal time boundary.

18. The apparatus of claim 17, wherein the one or more processors are further configured to cause the apparatus to:
receive a configuration parameter associated with the unsynchronized unlicensed access protocol; and
calculate the derived synchronization signal time boundary based at least in part on the configuration parameter.

19. The apparatus of claim 18, wherein the derived synchronization signal time boundary is a first derived synchronization signal time boundary, and
wherein the one or more processors are further configured to cause the apparatus to:
calculate a synchronization period between the first derived synchronization signal time boundary and a second derived synchronization signal time boundary based at least in part on a distributed coordinated function interframe space.

20. The apparatus of claim 17, wherein the unsynchronized unlicensed access protocol indicates that self-deferral by the apparatus is disallowed.

21. The apparatus of claim 17, wherein the one or more processors are further configured to cause the apparatus to:
restart a minimum time duration after completing transmission of the second communication.

22. The apparatus of claim 17, wherein the apparatus is at least part of a user equipment (UE), and
wherein the unsynchronized unlicensed access protocol indicates that transmission of an access probe is disallowed.

23. The apparatus of claim 17, wherein the one or more processors are further configured to cause the apparatus to:
perform a clear channel assessment procedure; and
detect, as part of the clear channel assessment procedure, a contention,
wherein the one or more processors are configured to cause the apparatus to defer transmission of the second communication based at least in part on detecting the contention.

24. The apparatus of claim 17, wherein the one or more processors are further configured to cause the apparatus to:
complete transmission of the second communication based at least in part on the derived synchronization signal time boundary.

25. The apparatus of claim 17, wherein the one or more processors are further configured to cause the apparatus to:
receive an indication of a minimum time duration from a primary network node,
wherein the one or more processors are configured to cause the apparatus to defer transmission of the second communication based at least in part on the minimum time duration.

26. A method of wireless communication performed by an apparatus, comprising:
transmitting a first communication based at least in part on using an unsynchronized unlicensed access protocol that is associated with a frequency band that is allocated to a licensed access mode and an unlicensed access mode; and
deferring, based at least in part on the unsynchronized unlicensed access protocol, transmission of a second communication based at least in part on a derived synchronization signal time boundary.

27. The method of claim 26, further comprising:
receiving a configuration parameter associated with the unsynchronized unlicensed access protocol; and
calculating the derived synchronization signal time boundary based at least in part on the configuration parameter.

28. The method of claim 27, wherein the configuration parameter comprises at least one of:
an energy threshold,
a contention window size,
a listen-before-talk configuration parameter,
an interframe space length,
a backoff configuration, or
a synchronization period.

29. The method of claim 26, further comprising:
performing a clear channel assessment procedure; and
detecting, as part of the clear channel assessment procedure, a contention,
wherein deferring transmission of the second communication is based at least in part on detecting the contention.

30. The method of claim 29, wherein performing the clear channel assessment procedure is based at least in part on a first energy detected threshold that is lower than a second energy detected threshold associated with synchronized unlicensed access.
